(19) United States
(12) Patent Application Publication
(10) Pub. No.: US 2025/0106333 A1
(43) Pub. Date: Mar. 27, 2025

(54) RECORDING MEDIUM PROCESSING APPARATUS AND IMAGE FORMING SYSTEM

(71) Applicant: FUJIFILM Business Innovation Corp., Tokyo (JP)

(72) Inventors: Katsumi TANAKA, Kanagawa (JP); Tomokazu KURITA, Kanagawa (JP); Raita DOI, Kanagawa (JP); Teisuke YANAGAWA, Kanagawa (JP)

(73) Assignee: FUJIFILM Business Innovation Corp., Tokyo (JP)

(21) Appl. No.: 18/587,983

(22) Filed: Feb. 27, 2024

(30) Foreign Application Priority Data
Sep. 27, 2023 (JP) 2023-164115

(51) Int. Cl. H04N 1/00

(52) U.S. Cl. CPC H04N 1/00612; H04N 1/00543; H04N 1/00615

(57) ABSTRACT

A recording medium processing apparatus includes an apparatus body; plural transport paths that are provided in the apparatus body and radially extend from a predetermined place and along which a transported recording medium passes; and plural opening and closing members that are openable and closable with respect to the apparatus body and are disposed so that positions thereof in a circumferential direction of the plural transport paths that are arranged radially are different.

### CROSS-REFERENCE TO RELATED APPLICATIONS

This application is based on and claims priority under 35 USC 119 from Japanese Patent Application No. 2023-164115 filed Sep. 27, 2023.

### BACKGROUND

### (i) Technical Field

The present disclosure relates to a recording medium processing apparatus and an image forming system.

### (ii) Related Art

U.S. Patent Application Publication No. 2003/0107169 discloses a sheet transport apparatus that includes first, second, third, and fourth roll pairs, in which a shaft of the third roll pair is oriented at an angle approximately 90° relative to a first shaft.

### SUMMARY

In some recording medium processing apparatuses that process a recording medium, plural transport paths along which a transported recording medium passes are provided.

If only one opening and closing member opened when a recording medium located on a transport path is accessed is provided corresponding to one of plural transport paths, an accessible region is narrow.

Aspects of non-limiting embodiments of the present disclosure relate to a technique of making it easier to access plural transport paths provided in a recording medium processing apparatus as compared with a configuration in which only one opening and closing member is provided corresponding to one of plural transport paths in a recording medium processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium processing apparatus including an apparatus body; plural transport paths that are provided in the apparatus body and radially extend from a predetermined place and along which a transported recording medium passes; and plural opening and closing members that are openable and closable with respect to the apparatus body and are disposed so that positions thereof in a circumferential direction of the plural transport paths that are arranged radially are different.

### BRIEF DESCRIPTION OF THE DRAWINGS

An exemplary embodiment of the present disclosure will be described in detail based on the following figures, wherein:

FIG. 1 is a front view illustrating an overall configuration of an image forming system;

FIG. 2 illustrates the image forming system viewed from above;

FIG. 3 illustrates a configuration of a controller provided in a third paper processing apparatus;

FIG. 4 illustrates a processing unit of the third paper processing apparatus viewed from above;

FIG. 5 illustrates a rotating mechanism viewed from a direction indicated by arrow V of FIG. 4;

FIGS. 6A and 6B illustrate a central side transport member provided in a pre-rotation transport mechanism viewed from a direction indicated by arrow VI of FIG. 4;

FIGS. 7A and 7B illustrate another example of the central side transport member and a structure around the central side transport member;

FIG. 8 illustrates a side wall side transport member provided in the pre-rotation transport mechanism;

FIGS. 9A and 9B illustrate a transport member provided in a first movement mechanism;

FIG. 10 illustrates a flow of processing in the third paper processing apparatus;

FIG. 11 illustrates a flow of processing in the third paper processing apparatus;

FIG. 12 illustrates a flow of processing in the third paper processing apparatus;

FIG. 13 illustrates a flow of processing in the third paper processing apparatus;

FIG. 14 illustrates a state of rotation of a lower transport member during rotation of paper;

FIG. 15 illustrates the third paper processing apparatus viewed from above;

FIGS. 16A and 16B are cross-sectional views of the third paper processing apparatus taken along line XVI-XVI of FIG. 15; and

FIG. 17 illustrates another example of a configuration of the third paper processing apparatus.

### DETAILED DESCRIPTION

An exemplary embodiment of the present disclosure is described below with reference to the drawings.

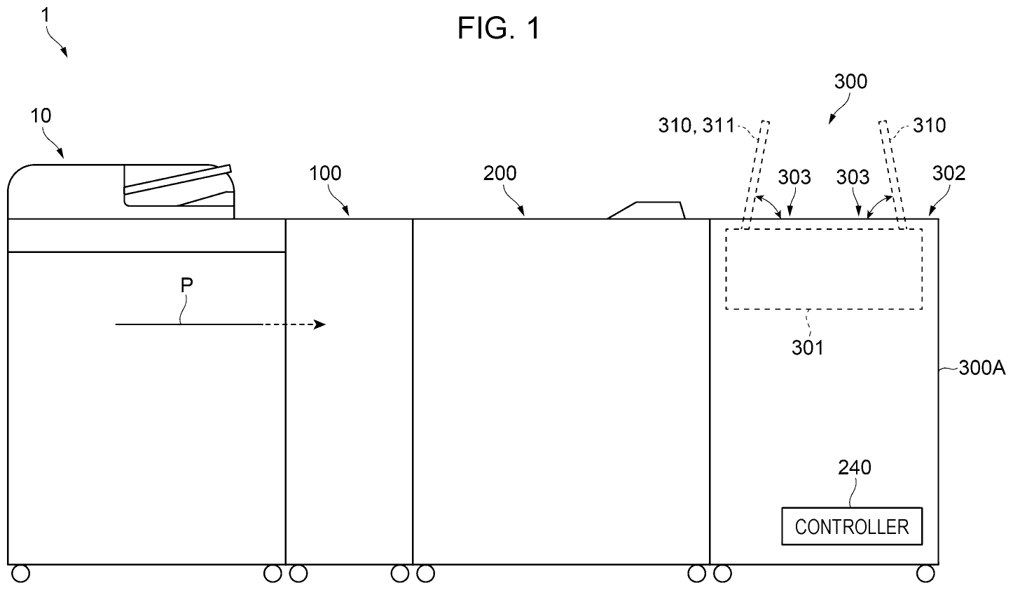

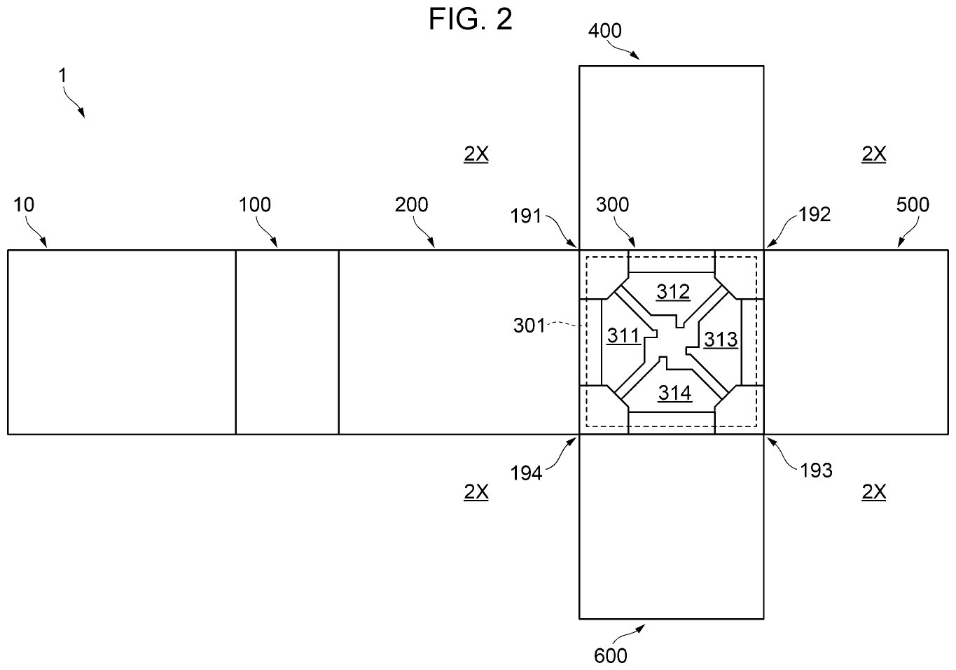

FIG. 1 is a front view illustrating an overall configuration of an image forming system 1. FIG. 2 illustrates the image forming system 1 viewed from above.

As illustrated in FIG. 1, the image forming system 1 according to the present exemplary embodiment includes an image forming apparatus 10 that forms an image on paper P, which is an example of a recording medium.

Furthermore, as illustrated in FIG. 2, the image forming system 1 includes a first paper processing apparatus 100 to a sixth paper processing apparatus 600. Note that only the first paper processing apparatus 100 to the third paper processing apparatus 300 are illustrated in FIG. 1.

Each of the first paper processing apparatus 100 (see FIG. 2) to the sixth paper processing apparatus 600 is disposed on a downstream side relative to the image forming apparatus 10 in a transport direction in which the paper P is transported, and performs processing on the paper P on which an image has been formed by the image forming apparatus 10.

Each of the first paper processing apparatus 100 to the third paper processing apparatus 300 performs processing on paper P transported from an immediately preceding paper processing apparatus located on an upstream side.

Each of the fourth paper processing apparatus 400 to the sixth paper processing apparatus 600 is disposed around the third paper processing apparatus 300. Each of the fourth paper processing apparatus 400 to the sixth paper processing apparatus 600 performs processing on paper P transported from the third paper processing apparatus 300.

Examples of the processing performed on paper P performed by the first paper processing apparatus 100 to the sixth paper processing apparatus 600 include folding processing, binding processing, punching processing, and booklet producing processing.

Other examples of the processing performed on paper P performed by the first paper processing apparatus 100 to the sixth paper processing apparatus 600 include processing of transporting the paper P and processing of rotating the paper P.

The processing performed by the first paper processing apparatus 100 to the sixth paper processing apparatus 600 include not only processing that involves change of a shape of the paper P, but also processing of moving the paper P or changing a posture of the paper P such as the processing of transporting the paper P and the processing of rotating the paper P.

The image forming apparatus 10 acquires image data from which an image is to be formed, for example, from a personal computer (PC) (not illustrated).

The image forming apparatus 10 forms an image on paper P, which is an example of a recording medium, on the basis of the acquired image data by using a material such as toner or ink.

Note that a mechanism for forming an image on paper P is not limited in particular. For example, an image is formed on the paper P by an electrophotographic system or an inkjet system.

The third paper processing apparatus 300 is described with reference to FIG. 1.

The third paper processing apparatus 300, which is an example of a recording medium processing apparatus, includes an apparatus body 300A, a processing unit 301 that performs processing on paper P transported from the second paper processing apparatus 200, and a controller 240 that controls the processing unit 301. The processing unit 301 is provided in the apparatus body 300A.

The third paper processing apparatus 300 has an opening and closing member 310 in an upper surface 302 thereof. In the present exemplary embodiment, when a user opens the opening and closing member 310, an opening 303 is formed in the upper surface 302 of the third paper processing apparatus 300. This allows the user to access the processing unit 301 through the opening 303.

In the present exemplary embodiment, the processing unit 301 of the third paper processing apparatus 300 performs processing of rotating paper P, as described later.

In the present exemplary embodiment, the paper P that has been rotated is transported to the fourth paper processing apparatus 400 (see FIG. 2) or the sixth paper processing apparatus 600 that is located on a downstream side relative to the third paper processing apparatus 300.

On the other hand, in a case where the paper P is transported from the third paper processing apparatus 300 (see FIG. 2) to the fifth paper processing apparatus 500, the paper P is transported to the fifth paper processing apparatus 500 without being rotated.

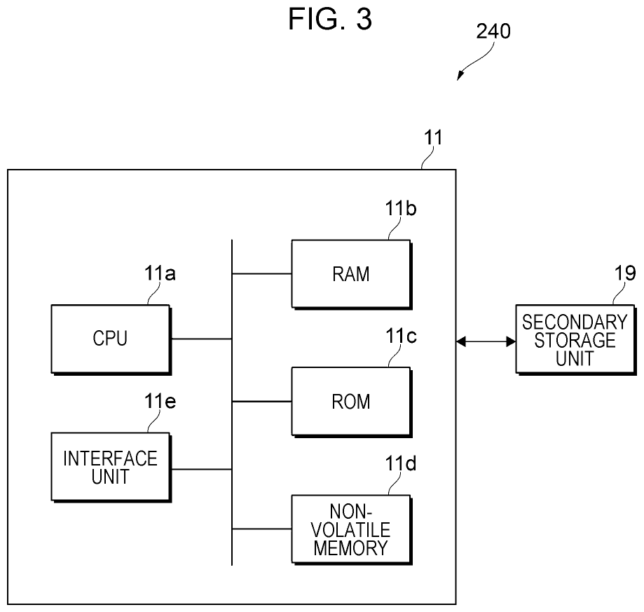

FIG. 3 illustrates a configuration of the controller 240 provided in the third paper processing apparatus 300. The controller 240 is a computer.

The controller 240 includes an arithmetic processing unit 11 that performs digital arithmetic processing in accordance with a program and a secondary storage unit 19 in which information is stored.

The secondary storage unit 19 is, for example, an existing information storage device such as a hard disk drive (HDD), a semiconductor memory, or a magnetic tape.

The arithmetic processing unit 11 includes a CPU 11a, which is an example of a processor.

The arithmetic processing unit 11 includes a RAM 11b used as a working memory or the like of the CPU 11a and a ROM 11c in which a program to be executed by the CPU 11a and others are stored.

Furthermore, the arithmetic processing unit 11 includes a non-volatile memory 11d that is rewritable and is capable of holding data even in a case where power supply is cut off and an interface unit 11e that controls units such as a communication unit connected to the arithmetic processing unit 11.

The non-volatile memory 11d is, for example, an SRAM, a flash memory, or the like backed up by a battery. In the secondary storage unit 19, various kinds of information such as a program to be executed by the arithmetic processing unit 11 is stored.

In the present exemplary embodiment, the arithmetic processing unit 11 performs processing performed in the third paper processing apparatus 300 by reading a program stored in the ROM 11c or the secondary storage unit 19.

The program to be executed by the CPU 11a may be offered to the third paper processing apparatus 300 by being stored in a computer-readable recording medium such as a magnetic recording medium (e.g., a magnetic tape, a magnetic disc), an optical recording medium (e.g., an optical disc), a magnetooptical recording medium, or a semiconductor memory. The program to be executed by the CPU 11a may be offered to the third paper processing apparatus 300 by using means of communication such as the Internet.

In the present specification, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

The term “processor” is broad enough to encompass one processor or plural processors in collaboration which are located physically apart from each other but may work cooperatively. The order of operations of the processor is not limited to one described in the present exemplary embodiment, and may be changed.

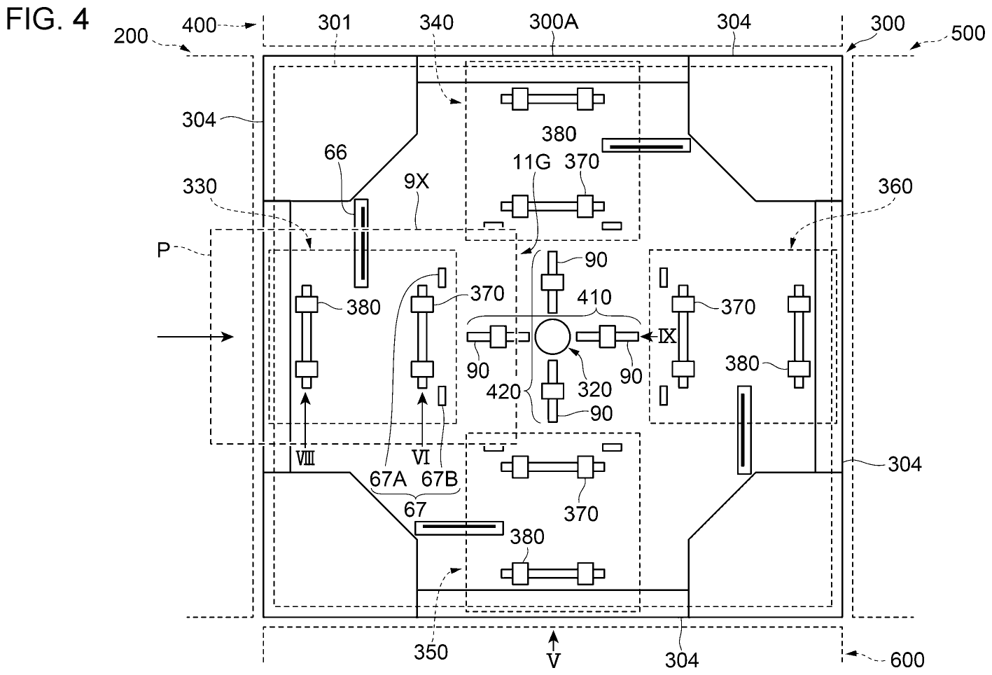

FIG. 4 illustrates the processing unit 301 of the third paper processing apparatus 300 viewed from above. In FIG. 4, illustration of the opening and closing member 310 is omitted. In FIG. 4, illustration of a support member, which will be described later, is also omitted.

The third paper processing apparatus 300 includes a rotating mechanism 320 that constitutes a part of a rotator that rotates paper P transported from the second paper processing apparatus 200.

The rotating mechanism 320 rotates paper P transported from the second paper processing apparatus 200. In the present exemplary embodiment, by rotating the paper P by the rotating mechanism 320, an orientation of the paper P is changed.

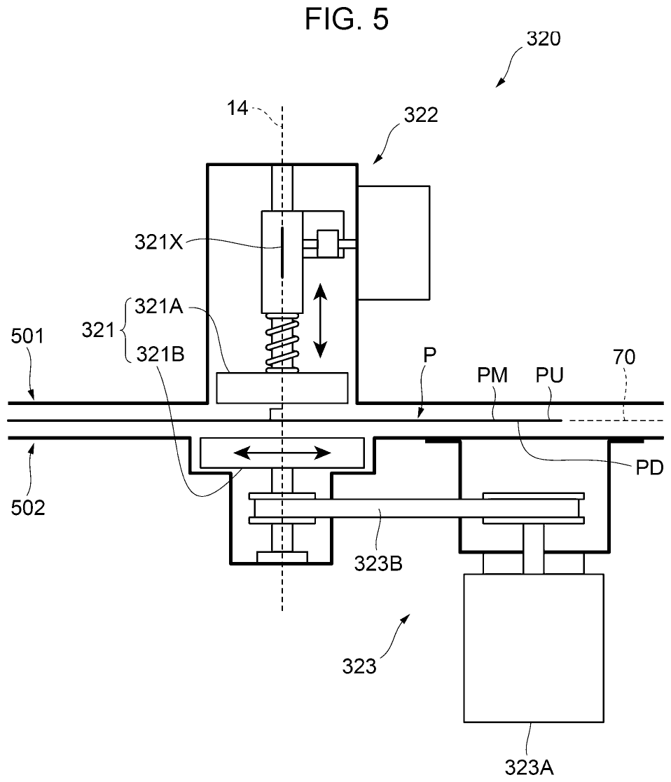

FIG. 5 illustrates the rotating mechanism 320 viewed from a direction indicated by arrow V of FIG. 4.

As illustrated in FIG. 5, the rotating mechanism 320 includes a rotating body 321.

The rotating body 321 is rotatable about a rotary axis 321X extending along a normal 14 to paper P to be rotated.

The rotary axis 321X extends along an up-down direction. The rotating body 321 rotates about the rotary axis 321X extending along the up-down direction. The rotating body 321 rotates while holding the paper P.

The rotating mechanism 320 rotates the paper P about the normal 14 by rotating the rotating body 321.

In the present exemplary embodiment, an upper rotating body 321A and a lower rotating body 321B are provided as the rotating body 321. The upper rotating body 321A and the lower rotating body 321B are coaxially provided.

The rotating mechanism 320 further includes an advancing/retreating mechanism 322 that advances and retreats the upper rotating body 321A with respect to the lower rotating body 321B and a drive mechanism 323 that rotates the lower rotating body 321B.

The advancing/retreating mechanism 322 advances and retreats the upper rotating body 321A with respect to the lower rotating body 321B by using a known existing technique.

A configuration of the advancing/retreating mechanism 322 is not limited in particular. The advancing/retreating mechanism 322 advances and retreats the upper rotating body 321A with respect to the lower rotating body 321B, for example, by using a cam mechanism, a link mechanism, a rack-and-pinion mechanism, a solenoid, or the like.

For example, in a case where a rack-and-pinion mechanism is used, a pinion that rotates about a rotary axis that extends along a direction orthogonal to an advancing/retreating direction of the upper rotating body 321A and a rack gear that moves in synch with the upper rotating body 321A, extends along the advancing/retreating direction of the upper rotating body 321A, and engages with the pinion gear are provided.

In this rack-and-pinion mechanism, when the pinion gear is rotated forward and reversed, the upper rotating body 321A advances and retreats with respect to the lower rotating body 321B.

The drive mechanism 323 transmits driving force generated by a drive source such as a motor to the lower rotating body 321B and thereby rotates the lower rotating body 321B.

Specifically, the drive mechanism 323 transmits driving force generated by the drive source to the lower rotating body 321B, for example, by using a belt transmission mechanism or a gear transmission mechanism and thereby rotates the lower rotating body 321B.

In the example illustrated in FIG. 5, driving force generated by the drive source 323A is transmitted to the lower rotating body 321B by using a belt 323B that circulates.

When the driving force is transmitted to the lower rotating body 321B, the lower rotating body 321B rotates about the rotary axis 321X extending along the normal 14 to the paper P to be rotated.

In the present exemplary embodiment, the paper P is sandwiched between the two rotating bodies 321, that is, the upper rotating body 321A and the lower rotating body 321B from both surfaces of the paper P, and thereby the paper P is held by the rotating body 321.

Specifically, the upper rotating body 321A moves down and is pressed against the lower rotating body 321B with the paper P interposed therebetween, and thereby the paper P is sandwiched between the two rotating bodies 321, that is, the upper rotating body 321A and the lower rotating body 321B.

In this way, the paper P is held by the two rotating bodies 321.

In the present exemplary embodiment, the two rotating bodies 321 that are holding the paper P are rotated.

Specifically, the lower rotating body 321B, which is one of the two rotating bodies 321 that are holding the paper P, is rotated by activating the drive mechanism 323.

As a result, the lower rotating body 321B, the upper rotating body 321A, and the paper P rotate about the normal 14 to a surface PM of the paper P.

In the present exemplary embodiment, the paper P transported from the second paper processing apparatus 200 thus rotates about the normal 14 to the surface PM of the paper P as the rotating body 321 rotates.

In the present exemplary embodiment, the upper rotating body 321A advances and retreats with respect to the lower rotating body 321B, and the lower rotating body 321B rotates.

However, this is not restrictive, and it is also possible to employ a configuration in which the lower rotating body 321B advances and retreats with respect to the upper rotating body 321A and the upper rotating body 321A rotates.

Although one of the upper rotating body 321A and the lower rotating body 321B advances and retreats and the other one of the upper rotating body 321A and the lower rotating body 321B rotates in the present exemplary embodiment, this is not restrictive.

For example, only one of the upper rotating body 321A and the lower rotating body 321B may advance and retreat and rotate.

Alternatively, both of the upper rotating body 321A and the lower rotating body 321B may advance and retreat.

A manner in which the paper P is held by the rotating body 321 is not limited to the aspect in which the paper P is sandwiched as described above. For example, the paper P may be held by the rotating body 321 by being sucked by the rotating body 321.

Furthermore, in the present exemplary embodiment, an upper guide member 501 that makes contact with an upper surface PU of the paper P and guides the paper P is provided above a transport path 70 along which the paper P is transported, as illustrated in FIG. 5.

Furthermore, a lower guide member 502 that guides the paper P is provided below the transport path 70 so as to face the upper guide member 501.

The lower guide member 502 is disposed so that a gap is present between the lower guide member 502 and the upper guide member 501. The lower guide member 502 guides the paper P while being in contact with a lower surface PD of the paper P.

The third paper processing apparatus 300 is described in more detail with reference to FIG. 4.

In the present exemplary embodiment, a pre-rotation transport mechanism 330 is provided, which is an example of a pre-rotation transporter that transports, toward a place where the rotating mechanism 320 is provided, the paper P transported from the second paper processing apparatus 200 located on an upstream side.

Furthermore, a first post-rotation transport mechanism 340 and a second post-rotation transport mechanism 350 are provided, which are an example of a post-rotation transporter that transports the paper P that has been rotated by the rotating mechanism 320 in a direction different from a transport direction in which the paper P is transported by the pre-rotation transport mechanism 330.

The first post-rotation transport mechanism 340 transports the paper P that has been rotated by the rotating mechanism 320 toward the fourth paper processing apparatus 400. The second post-rotation transport mechanism 350 transports the paper P that has been rotated by the rotating mechanism 320 toward the sixth paper processing apparatus 600.

The pre-rotation transport mechanism 330 that transports the paper P transported from the second paper processing apparatus 200 transports the paper P rightward in FIG. 4.

On the other hand, the first post-rotation transport mechanism 340 transports the paper P in an upward direction in FIG. 4, which is a direction different from the rightward direction. The second post-rotation transport mechanism 350 transports the paper P in a downward direction in FIG. 4, which is a direction different from the rightward direction.

Furthermore, in the present exemplary embodiment, a downstream side transport mechanism 360 is provided.

The downstream side transport mechanism 360 is disposed on a downstream side relative to the rotating mechanism 320 in the transport direction in which the paper P is transported by the pre-rotation transport mechanism 330.

The downstream side transport mechanism 360 transports, toward the fifth paper processing apparatus 500, the paper P transported by the pre-rotation transport mechanism 330. The paper P transported toward the fifth paper processing apparatus 500 passes the third paper processing apparatus 300 without being rotated by the rotating mechanism 320.

The downstream side transport mechanism 360 transports the paper P that is not rotated by the rotating mechanism 320 toward the fifth paper processing apparatus 500.

The pre-rotation transport mechanism 330, the first post-rotation transport mechanism 340, the second post-rotation transport mechanism 350, and the downstream side transport mechanism 360 each include a transport member that transports the paper P.

Specifically, the pre-rotation transport mechanism 330, the first post-rotation transport mechanism 340, the second post-rotation transport mechanism 350, and the downstream side transport mechanism 360 each include, as the transport member, a central side transport member 370 that is located close to the rotating mechanism 320 and is located close to a central part of the third paper processing apparatus 300.

Furthermore, the pre-rotation transport mechanism 330, the first post-rotation transport mechanism 340, the second post-rotation transport mechanism 350, and the downstream side transport mechanism 360 each include, as the transport member, a side wall side transport member 380 that is located away from the rotating mechanism 320 and is located close to a side wall 304 of the third paper processing apparatus 300.

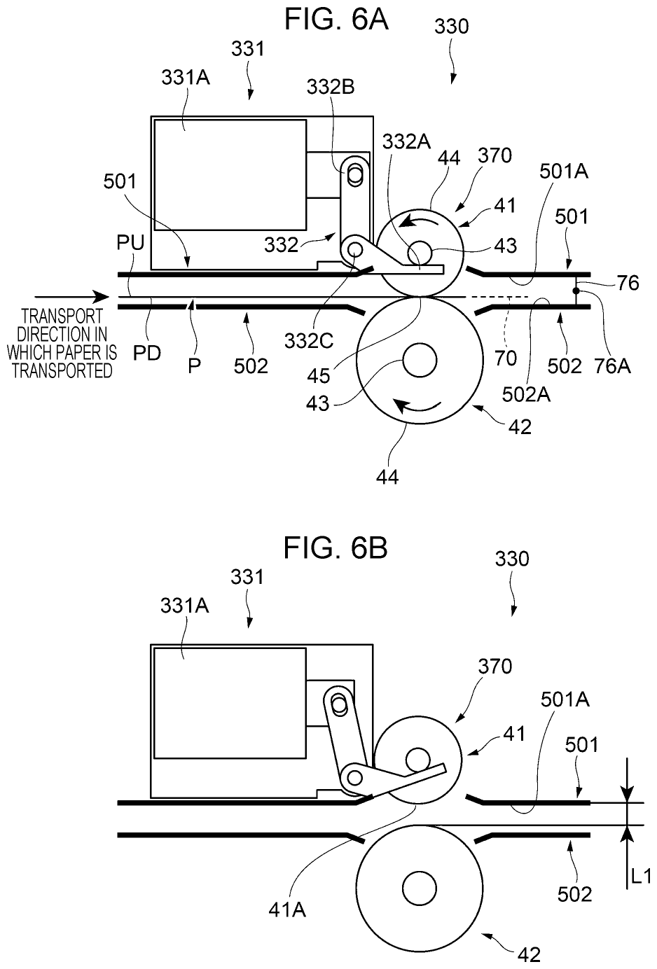

FIGS. 6A and 6B illustrate the central side transport member 370 provided in the pre-rotation transport mechanism 330 viewed from a direction indicated by arrow VI of FIG. 4.

Note that the central side transport members 370 provided in the first post-rotation transport mechanism 340, the second post-rotation transport mechanism 350, and the downstream side transport mechanism 360 also have configurations similar to the central side transport member 370 provided in the pre-rotation transport mechanism 330.

In the present exemplary embodiment, an upper transport member 41 and a lower transport member 42 are provided as the central side transport member 370, as illustrated in FIG. 6A. The central side transport member 370 includes the upper transport member 41 and the lower transport member 42, which are a pair of transport members.

Each of the upper transport member 41 and the lower transport member 42 is a transport roll, and includes a rotary shaft 43 and a cylindrical elastic body 44 attached to the rotary shaft 43, as illustrated in FIG. 6A.

The upper transport member 41 and the lower transport member 42 are transport members that transport the paper P by rotating. The upper transport member 41 makes contact with the upper surface PU, which is an upper surface of the paper P. The lower transport member 42 makes contact with the lower surface PD, which is a lower surface of the paper P.

In FIG. 6A, the upper transport member 41 and the lower transport member 42 are disposed in contact with each other. In the present exemplary embodiment, the upper transport member 41 is biased toward the lower transport member 42 by a biasing member (not illustrated).

In the present exemplary embodiment, an external diameter of the upper transport member 41 is smaller than an external diameter of the lower transport member 42.

In the present exemplary embodiment, one of the upper transport member 41 and the lower transport member 42 rotates upon receipt of driving force from a motor (not illustrated), and the other one of the upper transport member 41 and the lower transport member 42 rotates upon receipt of driving force from the one of the upper transport member 41 and the lower transport member 42.

Furthermore, in the present exemplary embodiment, an advancing/retreating mechanism 331 that advances and retreats the upper transport member 41 with respect to the lower transport member 42 is provided. In the present exemplary embodiment, the advancing/retreating mechanism 331 advances and retreats the upper transport member 41 with respect to the lower transport member 42.

The advancing/retreating mechanism 331 advances and retreats the upper transport member 41 with respect to the lower transport member 42 by using a solenoid 331A.

One end portion 332A of an L-shaped member 332 having an L shape is disposed below the rotary shaft 43 provided in the upper transport member 41.

In the present exemplary embodiment, when the solenoid 331A connected to an other end portion 332B of the L-shaped member 332 is turned on/off, the L-shaped member 332 rotates about a rotation center 332C.

As a result, the one end portion 332A of the L-shaped member 332 moves up and down, and the upper transport member 41 advances and retreats with respect to the lower transport member 42 accordingly.

When the upper transport member 41 moves away from the lower transport member 42 and retreats from the lower transport member 42, the upper transport member 41 is separated away from the lower transport member 42, as illustrated in FIG. 6B.

Note that the advancing/retreating mechanism 331 is not limited to the solenoid 331A, and may be another known mechanism such as a cam mechanism, a link mechanism, or a rack-and-pinion mechanism.

Although a case where the upper transport member 41 advances and retreats with respect to the lower transport member 42 has been described, the lower transport member 42 may advance and retreat with respect to the upper transport member 41.

In the present exemplary embodiment, the upper guide member 501 and the lower guide member 502 are also provided on an upstream side and a downstream side relative to the central side transport member 370 in the transport direction in which the paper P is transported by the central side transport member 370, as illustrated in FIG. 6A.

The upper guide member 501 is provided above the transport path 70 along which the paper P is transported.

The upper guide member 501 is disposed above the transport path 70 through which the paper P transported by the upper transport member 41 and the lower transport member 42 passes, and guides the paper P while being in contact with the upper surface PU of the paper P passing through the transport path 70.

In the present exemplary embodiment, the advancing/retreating mechanism 331 is placed on the upper guide member 501, and the advancing/retreating mechanism 331 is supported by the upper guide member 501.

The lower guide member 502 is disposed below the transport path 70 so as to face the upper guide member 501, and guides the paper P while being in contact with the lower surface PD of the paper P.

The lower guide member 502 is disposed below the transport path 70 along which the paper P is transported by the upper transport member 41 and the lower transport member 42, and guides the paper P while being in contact with the lower surface PD of the paper P passing through the transport path 70.

In the present exemplary embodiment, a contact part 45 between the upper transport member 41 and the lower transport member 42 is located closer to the lower guide member 502 than a midpoint 76A of a straight line 76 connecting the upper guide member 501 and the lower guide member 502, as illustrated in FIG. 6A.

The straight line 76 that connects the upper guide member 501 and the lower guide member 502 is a straight line 76 that connects a paper guide surface 501A of the upper guide member 501 that makes contact with the paper P and a paper guide surface 502A of the lower guide member 502 that makes contact with the paper P and extends along a direction orthogonal to the transport direction in which the paper P is transported.

The contact part 45 is located closer to the lower guide member 502 than the midpoint 76A of the straight line 76. The contact part 45 is located closer to the lower guide member 502 than the midpoint 76A when positions thereof in a direction in which the straight line 76 extends are compared.

In the present exemplary embodiment, when the paper P is rotated by the rotating mechanism 320 (see FIG. 4), the upper transport member 41 retreats from the lower transport member 42, and the upper transport member 41 is located above the paper guide surface 501A of the upper guide member 501, as illustrated in FIG. 6B.

More specifically, a lower end portion 41A of the upper transport member 41 is located above the paper guide surface 501A of the upper guide member 501.

In the configuration in which the lower end portion 41A of the upper transport member 41 is located above the paper guide surface 501A of the upper guide member 501 and the contact part 45 is located closer to the lower guide member 502 than the midpoint 76A as illustrated in FIG. 6A, a distance L1 (see FIG. 6B) is large.

More specifically, the distance L1 (see FIG. 6B) between the paper guide surface 501A of the upper guide member 501 and the lower transport member 42 is large in a state where the upper transport member 41 has retreated from the lower transport member 42.

In the present exemplary embodiment, in a state where the upper transport member 41 has retreated from the lower transport member 42, the distance L1 between the paper guide surface 501A and the lower transport member 42 is larger than in a configuration in which a position of the contact part 45 (FIG. 6A) and a position of the midpoint 76A match.

In this case, a load acting on the paper P that is being located by the rotating mechanism 320 is small, and the paper P easily rotates (details will be described later).

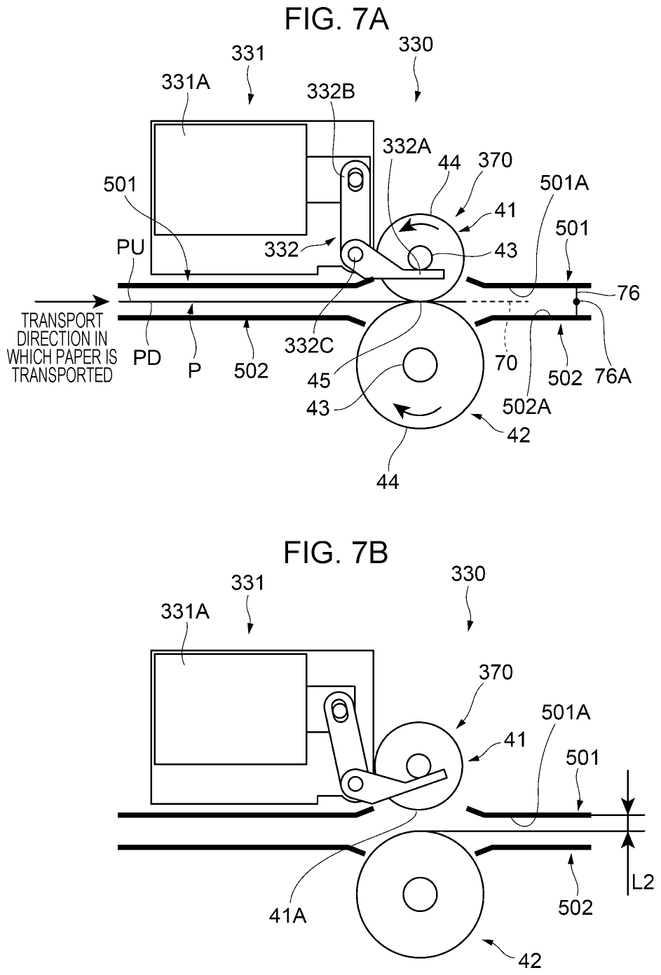

FIGS. 7A and 7B illustrate another example of the central side transport member 370 and a structure around the central side transport member 370.

In this example illustrated in FIGS. 7A and 7B, the position of the contact part 45 and the position of the midpoint 76A match, as illustrated in FIG. 7A.

In this case, as illustrated in FIG. 7B, a distance L2 between the paper guide surface 501A of the upper guide member 501 and the lower transport member 42 in a state where the upper transport member 41 has retreated from the lower transport member 42 is smaller than the distance L1.

In this configuration illustrated in FIGS. 7A and 7B, the upper guide member 501 and the lower transport member 42 are more likely to make contact with the paper P that is being rotated by the rotating mechanism 320, and a load on the rotating paper P is large.

On the other hand, in the configuration in which the contact part 45 is located closer to the lower guide member 502 than the midpoint 76A as illustrated in FIGS. 6A and 6B, the distance L1 between the paper guide surface 501A of the upper guide member 501 and the lower transport member 42 is large, as described above.

In this case, a load on the rotating paper P is small, and the paper P easily rotates.

Alternatively, the contact part 45 between the upper transport member 41 and the lower transport member 42 may be located closer to the upper guide member 501 than the midpoint 76A of the straight line 76 connecting the upper guide member 501 and the lower guide member 502.

As described above, in the present exemplary embodiment, it is possible to employ a configuration in which the lower transport member 42 moves downward to retreat from the upper transport member 41.

In the configuration in which the contact part 45 is located closer to the upper guide member 501 than the midpoint 76A of the straight line 76, a distance between the paper guide surface 502A of the lower guide member 502 and the upper transport member 41 is large.

More specifically, the distance between the paper guide surface 502A of the lower guide member 502 and the upper transport member 41 in a state where the lower transport member 42 has retreated from the upper transport member 41 and is located below the paper guide surface 502A of the lower guide member 502 is larger.

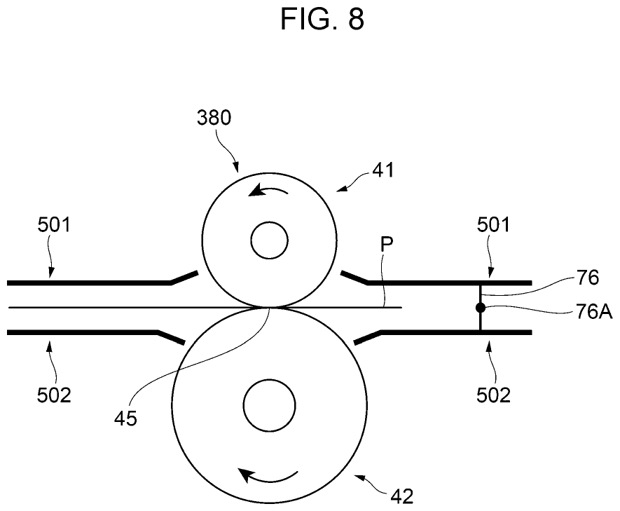

FIG. 8 illustrates the side wall side transport member 380 provided in the pre-rotation transport mechanism 330 illustrated in FIG. 4. FIG. 8 illustrates the side wall side transport member 380 viewed from a direction indicated by arrow VIII of FIG. 4.

Note that the side wall side transport members 380 provided in the first post-rotation transport mechanism 340, the second post-rotation transport mechanism 350, and the downstream side transport mechanism 360 also have configurations similar to the side wall side transport member 380 provided in the pre-rotation transport mechanism 330.

As illustrated in FIG. 8, the side wall side transport member 380 also includes an upper transport member 41 and a lower transport member 42, which are a pair of transport members, as with the central side transport member 370.

The upper guide member 501 and the lower guide member 502 are provided on an upstream side and a downstream side relative to the side wall side transport member 380 in the transport direction in which the paper P is transported, as with the central side transport member 370.

In a place where the side wall side transport member 380 is provided, a position of the contact part 45 between the upper transport member 41 and the lower transport member 42 and a position of the midpoint 76A of the straight line 76 connecting the upper guide member 501 and the lower guide member 502 are the same.

In the place where the side wall side transport member 380 is provided, the position of the contact part 45 between the upper transport member 41 and the lower transport member 42 and the position of the midpoint 76A of the straight line 76 match in a case where the positions in a direction in which the straight line 76 extends are compared.

In the present exemplary embodiment, the paper P is not located between the upper transport member 41 and the lower transport member 42 that constitute the side wall side transport member 380 while the paper P is being rotated by the rotating mechanism 320 (details will be described later).

In this case, in the place where the side wall side transport member 380 is provided, the upper guide member 501, the lower guide member 502, the upper transport member 41, and the lower transport member 42 do not make contact with the rotating paper P.

In this case, an increase in load on the paper P caused by contact of these members with the rotating paper P does not occur.

Therefore, in the present exemplary embodiment, the position of the contact part 45 and the position of the midpoint 76A are not shifted from each other in the place where the side wall side transport member 380 is provided.

The configuration of the processing unit 301 is further described with reference to FIG. 4.

In the present exemplary embodiment, a first movement mechanism 410 is further provided, as illustrated in FIG. 4.

The first movement mechanism 410, which is an example of a mover, causes the paper P transported to the rotating mechanism 320 by the pre-rotation transport mechanism 330 to move in a crossing direction that crosses the transport direction in which the paper P is transported by the pre-rotation transport mechanism 330.

More specifically, the first movement mechanism 410 causes the paper P transported to the rotating mechanism 320 by the pre-rotation transport mechanism 330 to move in a direction orthogonal to the transport direction in which the paper P is transported by the pre-rotation transport mechanism 330.

Furthermore, in the present exemplary embodiment, a second movement mechanism 420 is provided, and the second movement mechanism 420 causes the paper P transported to the rotating mechanism 320 by the pre-rotation transport mechanism 330 to moves to a downstream side in the transport direction in which the paper P is transported by the pre-rotation transport mechanism 330.

The first movement mechanism 410 and the second movement mechanism 420 each include a transport member 90 that transports the paper P.

More specifically, the first movement mechanism 410 includes two transport members 90 that transport the paper P. The second movement mechanism 420 also includes two transport members 90 that transport the paper P.

In the present exemplary embodiment, the rotating mechanism 320 is provided between the two transport members 90 provided in the first movement mechanism 410. In the present exemplary embodiment, the rotating mechanism 320 is provided between the two transport members 90 provided in the second movement mechanism 420.

When the paper P is moved by the first movement mechanism 410, the two transport members 90 provided in the first movement mechanism 410 rotate in the same direction.

When the paper P is moved by the second movement mechanism 420, the two transport members 90 provided in the second movement mechanism 420 rotate in the same direction.

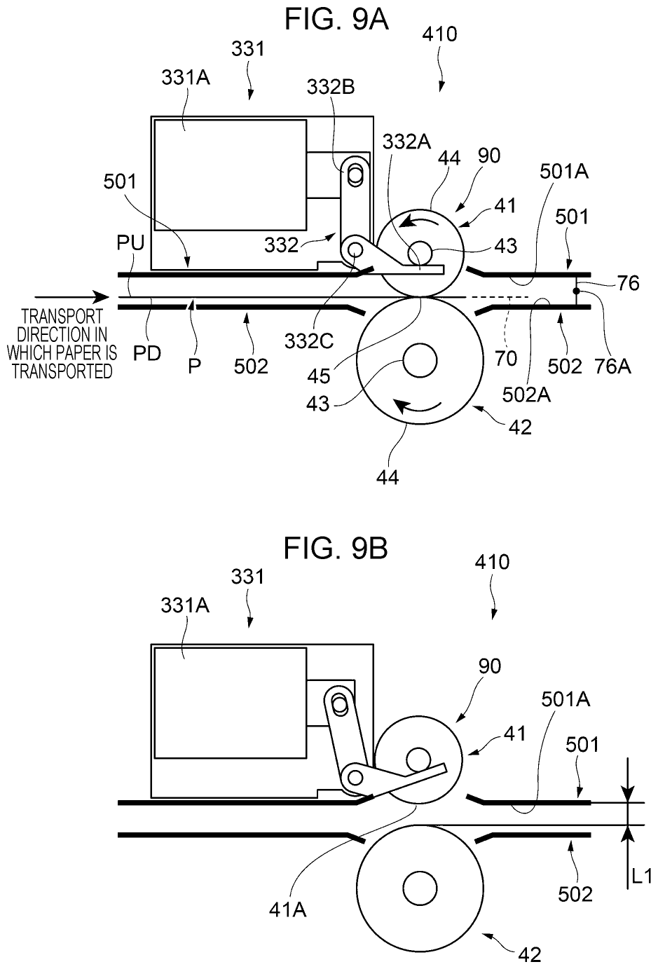

FIGS. 9A and 9B illustrate the transport member 90 provided in the first movement mechanism 410. FIGS. 9A and 9B illustrate the transport member 90 provided in the first movement mechanism 410 viewed from a direction indicated by arrow IX of FIG. 4.

FIGS. 9A and 9B illustrate one of the two transport members 90 provided in the first movement mechanism 410. The other one of the two transport members 90 has a configuration similar to the one transport member 90.

The transport members 90 provided in the second movement mechanism 420 (see FIG. 4) also have configurations similar to the transport members 90 provided in the first movement mechanism 410.

As illustrated in FIGS. 9A and 9B, the transport members 90 provided in the first movement mechanism 410 have configurations similar to the central side transport member 370.

As illustrated in FIG. 9A, the transport member 90 provided in the first movement mechanism 410 includes a pair of transport members. Specifically, the transport member 90 provided in the first movement mechanism 410 includes an upper transport member 41 located on an upper side and a lower transport member 42 located on a lower side, as with the central side transport member 370.

The upper transport member 41 is advanced and retreated with respect to the lower transport member 42 by the advancing/retreating mechanism 331 supported by the upper guide member 501.

Also in the transport member 90 provided in the first movement mechanism 410, the contact part 45 is located closer to the lower guide member 502 than the midpoint 76A of the straight line 76 connecting the upper guide member 501 and the lower guide member 502, as illustrated in FIG. 9A.

As described later, in the present exemplary embodiment, the paper P passes between the upper transport member 41 and the lower transport member 42 provided in the first movement mechanism 410 when the paper P is rotated by the rotating mechanism 320.

In this case, in a case where the contact part 45 is located closer to the lower guide member 502 than the midpoint 76A of the straight line 76 connecting the upper guide member 501 and the lower guide member 502, a load acting on the paper P decreases, and the paper P more smoothly rotates, as in the case of the central side transport member 370.

The first movement mechanism 410 (see FIG. 4) causes the paper P transported by the pre-rotation transport mechanism 330 to move in the crossing direction crossing the transport direction in which the paper P is transported by the pre-rotation transport mechanism 330.

Specifically, the first movement mechanism 410 causes the paper P transported by the pre-rotation transport mechanism 330 move toward a side where the first post-rotation transport mechanism 340 is provided or a side where the second post-rotation transport mechanism 350 is provided.

The first movement mechanism 410 causes the paper P transported by the pre-rotation transport mechanism 330 to move in the crossing direction before the paper P is rotated by the rotating mechanism 320.

More specifically, in a case where the position of the paper P is deviated in the crossing direction, the first movement mechanism 410 moves the paper P in the crossing direction before the paper P is rotated by the rotating mechanism 320.

Details of movement of the paper by the first movement mechanism 410 will be described later.

The second movement mechanism 420 (see FIG. 4) causes the paper P that is not rotated by the rotating mechanism 320 to move not in the crossing direction, but toward the side where the downstream side transport mechanism 360 is provided.

In other words, the second movement mechanism 420 causes the paper P that is transported by the pre-rotation transport mechanism 330 and is not rotated by the rotating mechanism 320 to further move to a downstream side in the transport direction in which the paper P is transported by the pre-rotation transport mechanism 330.

Furthermore, in the present exemplary embodiment, a position detection sensor 66 that detects a position of a side 9X of the paper P transported by the pre-rotation transport mechanism 330 is provided, as illustrated in FIG. 4.

Furthermore, in the present exemplary embodiment, a paper detection sensor 67 that detects the paper P transported by the pre-rotation transport mechanism 330 is provided. The paper detection sensor 67 detects a leading end portion 11G of the paper P in the transport direction in which the paper P is transported by the pre-rotation transport mechanism 330.

In the present exemplary embodiment, a first paper detection sensor 67A and a second paper detection sensor 67B are provided as the paper detection sensor 67.

The first paper detection sensor 67A and the second paper detection sensor 67B are disposed so that positions thereof in the crossing direction are different.

In the present exemplary embodiment, a position of the first paper detection sensor 67A and a position of the second paper detection sensor 67B in the transport direction in which the paper P is transported by the pre-rotation transport mechanism 330 match.

In the present exemplary embodiment, the paper detection sensor 67 is provided on an upstream side relative to the rotating mechanism 320 in the transport direction in which the paper P is transported by the pre-rotation transport mechanism 330.

The position detection sensor 66 is provided on an upstream side relative to the paper detection sensor 67 in the transport direction in which the paper P is transported by the pre-rotation transport mechanism 330.

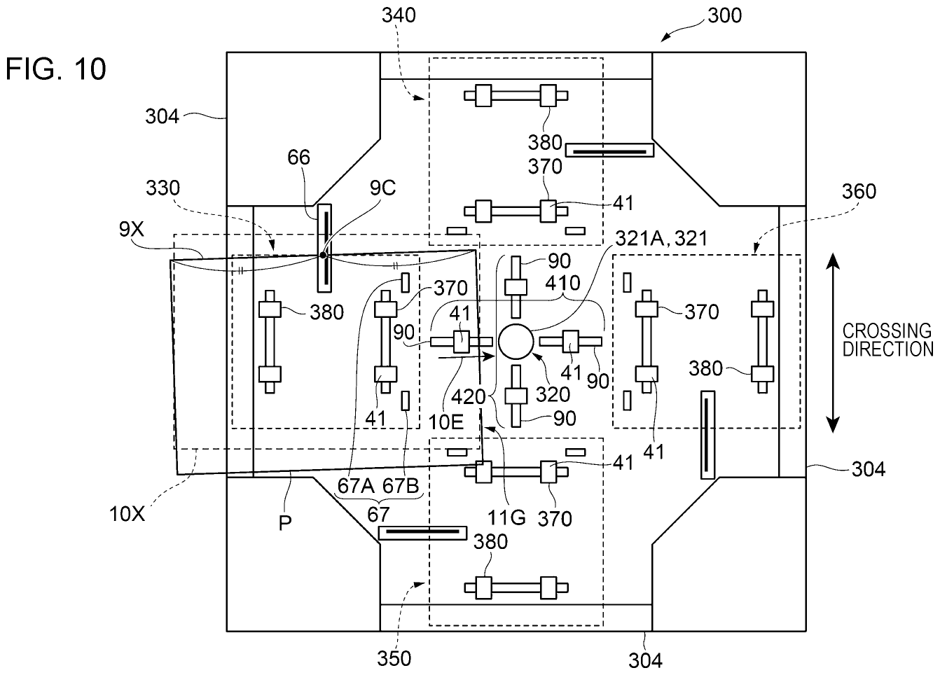

FIGS. 10 to 13 illustrate a flow of processing in the third paper processing apparatus 300.

The following describes a processing example in which the paper P delivered from the second paper processing apparatus 200 (see FIG. 2) is transported to the fourth paper processing apparatus 400 via the third paper processing apparatus 300.

In the present exemplary embodiment, first, the paper P transported from the second paper processing apparatus 200 (not illustrated in FIG. 10) is transported by the pre-rotation transport mechanism 330, as illustrated in FIG. 10.

In the present exemplary embodiment, the upper transport member 41 provided in the first movement mechanism 410 is separated away from the lower transport member 42 (not illustrated in FIG. 10) when the paper P is transported by the pre-rotation transport mechanism 330.

The upper transport member 41 that constitutes the central side transport member 370 provided in each of the first post-rotation transport mechanism 340 and the second post-rotation transport mechanism 350 is separated away from the lower transport member 42 (not illustrated in FIG. 10) when the paper P is transported by the pre-rotation transport mechanism 330.

The upper rotating body 321A is in a state of having retreated from the lower rotating body 321B (not illustrated in FIG. 10) and being separated away from the lower rotating body 321B when the paper P is transported by the pre-rotation transport mechanism 330.

Furthermore, each of the pre-rotation transport mechanism 330, the second movement mechanism 420, and the downstream side transport mechanism 360 is driven when the paper P is transported by the pre-rotation transport mechanism 330.

In this processing example, the paper P transported by the pre-rotation transport mechanism 330 is deviated in the crossing direction crossing the transport direction in which the paper P is transported, as illustrated in FIG. 10. In this processing example, the paper P is inclined with respect to the transport direction in which the paper P is transported, as illustrated in FIG. 10.

In FIG. 10, an originally planned transport state of the paper P is expressed by the broken line indicated by reference sign 10X.

In the state illustrated in FIG. 10, the paper P actually transported by the pre-rotation transport mechanism 330 is deviated in the crossing direction and is inclined with respect to the transport direction in which the paper P is transported.

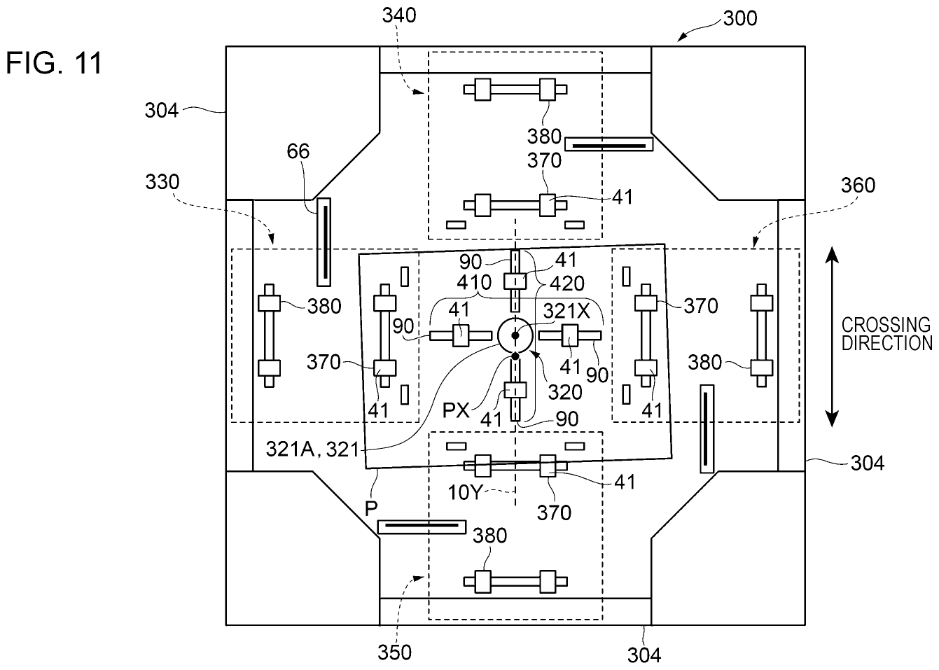

Then, in this processing example, the paper P stops at the place where the rotating mechanism 320 is provided, as illustrated in FIG. 11. As a result, the paper P is located between the upper rotating body 321A and the lower rotating body 321B (not illustrated in FIG. 11) that are provided in the rotating mechanism 320.

In the present exemplary embodiment, transport of the paper P is stopped once, resulting in a state where the paper P is located between the upper rotating body 321A and the lower rotating body 321B. In other words, in the present exemplary embodiment, transport of the paper P is stopped once, resulting in a state where the paper P has reached the rotating mechanism 320.

In the present exemplary embodiment, a timing at which the leading end portion 11G of the paper P is detected by the paper detection sensor 67 (see FIG. 10) is used as a reference timing.

When a predetermined period elapses from the reference timing, driving of the pre-rotation transport mechanism 330 (see FIG. 11), the second movement mechanism 420, and the downstream side transport mechanism 360 is stopped. More specifically, rotation of the transport member provided in each of the pre-rotation transport mechanism 330, the second movement mechanism 420, and the downstream side transport mechanism 360 is stopped.

As a result, in the present exemplary embodiment, a position of a central portion PX of the paper P and a position of the rotating body 321 in the transport direction in which the paper P is transported match.

The “transport direction” here refers to the transport direction in which the paper P is transported by the pre-rotation transport mechanism 330.

FIG. 11 illustrates a state where the position of the central portion PX of the paper P and the position of the rotating body 321 in the transport direction in which the paper P is transported match.

The “predetermined period” is a period it takes for the central portion PX of the paper P to reach a virtual straight line 10Y passing the rotary axis 321X of the rotating body 321 and extending in a direction orthogonal to the transport direction in which the paper P is transported by the pre-rotation transport mechanism 330.

In the present exemplary embodiment, when transport of the paper P is stopped upon elapse of the “predetermined period”, the position of the central portion PX of the paper P and the position of the rotating body 321 in the transport direction in which the paper P is transported by the pre-rotation transport mechanism 330 match.

More specifically, the position of the central portion PX of the paper P in the transport direction and the position of the rotary axis 321X, which is a rotation center of the rotating body 321, in the transport direction match.

The “central portion PX of the paper P” here refers to a portion where two diagonal lines of the paper P having a rectangular shape cross each other.

In the present exemplary embodiment, in a case where a time difference between a timing at which the paper P is detected by the first paper detection sensor 67A (see FIG. 10) and a timing at which the paper P is detected by the second paper detection sensor 67B is smaller than a predetermined threshold value, rotation of the transport members is stopped after elapse of the “predetermined period” from the timing at which the paper P is detected by the first paper detection sensor 67A.

In other words, in the present exemplary embodiment, in a case where the paper P is not inclined or inclination of the paper P is small, rotation of the transport members is stopped after elapse of the “predetermined period” from the timing at which the paper P is detected by the first paper detection sensor 67A.

Specifically, rotation of the side wall side transport member 380 and the central side transport member 370 provided in each of the pre-rotation transport mechanism 330 and the downstream side transport mechanism 360 and the transport members 90 provided in the second movement mechanism 420 is stopped.

Note that rotation of the transport members may be stopped after elapse of the “predetermined period” from the timing at which the paper P is detected by the second paper detection sensor 67B instead of the timing at which the paper P is detected by the first paper detection sensor 67A.

In the present exemplary embodiment, the timing at which the paper P is detected by the first paper detection sensor 67A is used as the reference timing, and rotation of the transport members is stopped after elapse of the “predetermined period” from the reference timing.

As a result, as described above, the position of the central portion PX of the paper P and the position of the rotary axis 321X of the rotating body 321 in the transport direction in which the paper P is transported by the pre-rotation transport mechanism 330 match.

On the other hand, in a case where the time difference between the timing at which the paper P is detected by the first paper detection sensor 67A and the timing at which the paper P is detected by the second paper detection sensor 67B is larger than the predetermined threshold value, the “predetermined period” is corrected. When the corrected “predetermined period” elapses, rotation of the transport members is stopped.

In the present exemplary embodiment, in a case where the paper P is inclined and the timing at which the paper P is detected by the first paper detection sensor 67A and the timing at which the paper P is detected by the second paper detection sensor 67B are markedly different, the “predetermined period” is increased or decreased to change the stop timing.

In a case where the paper P is inclined with respect to the transport direction, the timing at which the paper P is detected by the first paper detection sensor 67A (see FIG. 10) and the timing at which the paper P is detected by the second paper detection sensor 67B are different.

In a case where the inclination of the paper P is large, the time difference between the timing at which the paper P is detected by the first paper detection sensor 67A and the timing at which the paper P is detected by the second paper detection sensor 67B is larger than the predetermined threshold value.

In such a case where the time difference is larger than the predetermined threshold value, the “predetermined period” is corrected, and rotation of the transport members is stopped upon elapse of the corrected “predetermined period”.

In a case where the “predetermined period” is corrected, rotation of the transport members is stopped after elapse of the corrected “predetermined period” from detection of the paper P by the first paper detection sensor 67A.

As a result, also in this case, the position of the central portion PX of the paper P that has stopped and the position of the rotary axis 321X of the rotating body 321 in the transport direction in which the paper P is transported by the pre-rotation transport mechanism 330 match.

In the present exemplary embodiment, a relationship table describing a relationship between a time difference and a correction value is stored in the secondary storage unit 19 (see FIG. 3), and the CPU 11a obtains a correction value corresponding to the time difference by referring to the relationship table.

The CPU 11a corrects the initial “predetermined period” by using the correction value and thus obtains a corrected “predetermined period”.

The CPU 11a stops rotation of the transport members when the corrected “predetermined period” elapses from the timing at which the paper P is detected by the first paper detection sensor 67A.

As a result, even in a case where the paper P is inclined, the position of the central portion PX of the paper P and the position of the rotary axis 321X of the rotating body 321 match in the transport direction in which the paper P is transported by the pre-rotation transport mechanism 330.

In this processing example, after rotation of the transport members stops and the paper P stops, the upper transport member 41 provided in the first movement mechanism 410 (see FIG. 11) advances, and the paper P is sandwiched between the upper transport member 41 and the lower transport member 42 (not illustrated in FIG. 11).

Furthermore, after the paper P stops, the upper transport member 41 provided in the second movement mechanism 420 retreats, and this upper transport member 41 is separated away from the lower transport member 42 (not illustrated in FIG. 11).

Furthermore, after the paper P stops, the upper transport member 41 that constitutes the central side transport member 370 provided in each of the pre-rotation transport mechanism 330 and the downstream side transport mechanism 360 retreats, and this upper transport member 41 is separated away from the lower transport member 42 (not illustrated in FIG. 11).

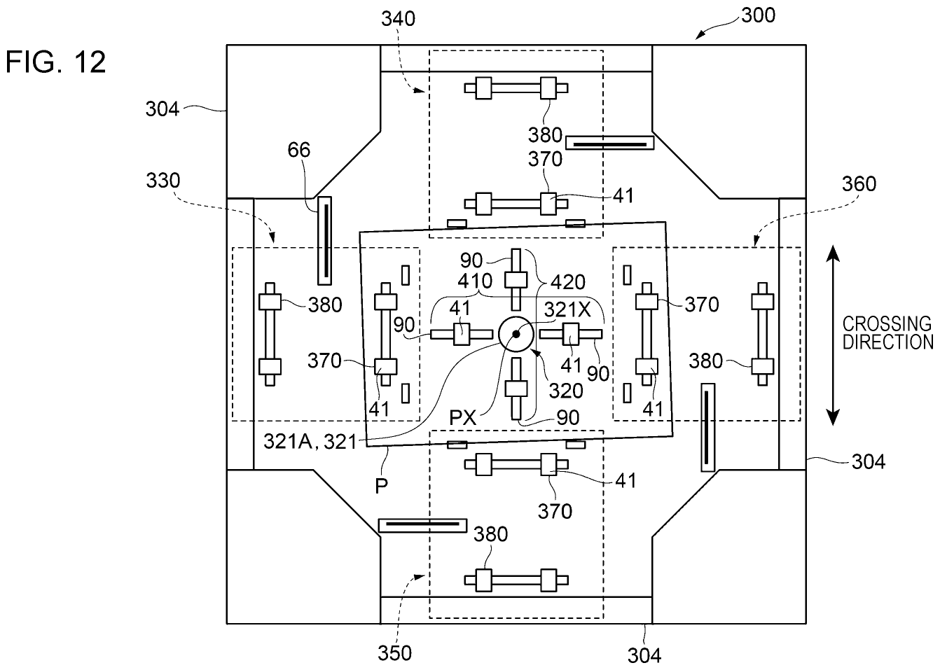

Next, as illustrated in FIG. 12, the first movement mechanism 410 moves the paper P in the crossing direction crossing the transport direction in which the paper P is transported by the pre-rotation transport mechanism 330.

Specifically, the first movement mechanism 410 causes the paper P transported by the pre-rotation transport mechanism 330 to move in a direction orthogonal to the transport direction in which the paper P is transported by the pre-rotation transport mechanism 330.

More specifically, in the present exemplary embodiment, the upper transport member 41 and the lower transport member 42 (not illustrated in FIG. 12) that are provided in the first movement mechanism 410 are driven to rotate, and thus the paper P travels toward the side where the rotating mechanism 320 is provided.

The first movement mechanism 410 moves the paper P toward a side opposite to a side toward which the paper P is deviated.

As a result, in the present exemplary embodiment, the position of the central portion PX of the paper P and the position of the rotary axis 321X located at a rotation center of the rotating body 321 match in the direction in which the paper P is moved by the first movement mechanism 410, as illustrated in FIG. 12.

In the present exemplary embodiment, the CPU 11a (see FIG. 3), which is an example of a processor, sets an amount by which the paper P is moved by the first movement mechanism 410.

Specifically, the CPU 11a sets an amount by which the paper P is moved by the first movement mechanism 410 on the basis of a position of the paper P in the crossing direction crossing the transport direction in which the paper P is transported by the pre-rotation transport mechanism 330.

More specifically, the CPU 11a specifies the position of the paper P in the crossing direction on the basis of an output from the position detection sensor 66 (see FIG. 10), and sets an amount by which the paper P is moved by the first movement mechanism 410 on the basis of the specified position.

More specifically, the CPU 11a specifies a position of the side 9X of the paper P on the basis of an output from the position detection sensor 66 when the paper P is moved toward the rotating mechanism 320 by the pre-rotation transport mechanism 330 (see FIG. 10).

In other words, the CPU 11a specifies the position of the side 9X extending along the transport direction in which the paper P is transported by the pre-rotation transport mechanism 330 among sides of the paper P.

More specifically, the CPU 11a specifies the position of the side 9X in the crossing direction on the basis of an output from the position detection sensor 66.

Then, the CPU 11a specifies the position of the paper P in the crossing direction on the basis of the specified position of the side 9X and sets an amount by which the paper P is moved by the first movement mechanism 410 (see FIG. 12) on the basis of the specified position.

More specifically, the CPU 11a sets the amount of movement on the basis of a position of a midpoint 9C of the side 9X of the paper P (see FIG. 10) transported to the rotating mechanism 320.

In other words, the CPU 11a sets the amount of movement on the basis of a position of a central portion of the paper P transported to the rotating mechanism 320 in a direction in which the side 9X extends.

More specifically, the CPU 11a sets the amount of movement on the basis of the position of the midpoint 9C of the side 9X in the crossing direction.

More specifically, the CPU 11a sets, as the amount of movement, a distance between the specified position of the midpoint 9C and a predetermined reference position.

When the CPU 11a sets the amount of movement, the CPU 11a controls rotation of the two transport members 90 provided in the first movement mechanism 410 (see FIG. 12) so that the paper P moves by the amount thus set. In this way, the paper P moves, so that the position of the paper P in the crossing direction is no longer deviated.

As a result, in the present exemplary embodiment, the position of the central portion PX of the paper P and the position of the rotary axis 321X located at a rotation center of the rotating body 321 match in the direction in which the paper P is moved by the first movement mechanism 410.

In the present exemplary embodiment, when the paper P transported to the rotating mechanism 320 by the pre-rotation transport mechanism 330 stops, the position of the central portion PX of the paper P and the position of the rotary axis 321X of the rotating body 321 match in the transport direction in which the paper P is transported by the pre-rotation transport mechanism 330, as illustrated in FIG. 11.

Furthermore, in the present exemplary embodiment, when the paper P that is moved in the crossing direction by the first movement mechanism 410 stops, the position of the central portion PX of the paper P and the position of the rotary axis 321X of the rotating body 321 match in the crossing direction, as illustrated in FIG. 12.

As a result, in the present exemplary embodiment, when the movement of the paper P by the first movement mechanism 410 ends, the central portion PX of the paper P is located between the upper rotating body 321A and the lower rotating body 321B (not illustrated in FIG. 12), as illustrated in FIG. 12.

In the present exemplary embodiment, the amount of movement is set on the basis of the position, in the crossing direction, of the midpoint 9C of the side 9X of the paper P (see FIG. 10) transported to the rotating mechanism 320, as described above.

In the present exemplary embodiment, the position of the midpoint 9C in the crossing direction is specified on the basis of an output from the position detection sensor 66.

The position detection sensor 66 includes plural light receiving elements arranged in the crossing direction, and the CPU 11a specifies the position of the midpoint 9C on the basis of an output from the plural light receiving elements.

More specifically, the CPU 11a specifies the position of the midpoint 9C on the basis of information that is output from the position detection sensor 66 when the midpoint 9C of the side 9X reaches the position detection sensor 66.

More specifically, in the present exemplary embodiment, the position of the midpoint 9C in the crossing direction is specified on the basis of information that is output from the position detection sensor 66 when a “predetermined period” elapses from a timing at which the leading end portion 11G of the paper P in the transport direction is detected by the paper detection sensor 67.

In the present exemplary embodiment, the midpoint 9C reaches the position detection sensor 66 when the “predetermined period” elapses. In the present exemplary embodiment, the position of the midpoint 9C in the crossing direction is specified on the basis of information that is output from the position detection sensor 66 when the “predetermined period” elapses.

Note that in a case where the paper P is inclined, the “predetermined period” is corrected, and the position of the midpoint 9C in the crossing direction is specified on the basis of information that is output from the position detection sensor 66 when the corrected “predetermined period” elapses.

In the present exemplary embodiment, in a case where the time difference between the timing at which the paper P is detected by the first paper detection sensor 67A and the timing at which the paper P is detected by the second paper detection sensor 67B is larger than a predetermined threshold value, the “predetermined period” is corrected.

In a case where the “predetermined period” is corrected, the position of the midpoint 9C in the crossing direction is specified on the basis of information that is output from the position detection sensor 66 when the corrected “predetermined period” elapses.

More specifically, in the present exemplary embodiment, a relationship table describing correspondence between a time difference and a correction value is stored in advance in the secondary storage unit 19 (see FIG. 3). The CPU 11a obtains a correction value corresponding to the time difference by referring to the relationship table.

The CPU 11a corrects the “predetermined period” by using the correction value and obtains the corrected “predetermined period”.

The CPU 11a uses, for example, detection of the paper P by the first paper detection sensor 67A as a reference timing, and specifies the position of the midpoint 9C in the crossing direction on the basis of information that is output from the position detection sensor 66 when the corrected “predetermined period” elapses from the reference timing.

This makes it possible to specify the position of the midpoint 9C in the crossing direction even in a case where the paper P is inclined.

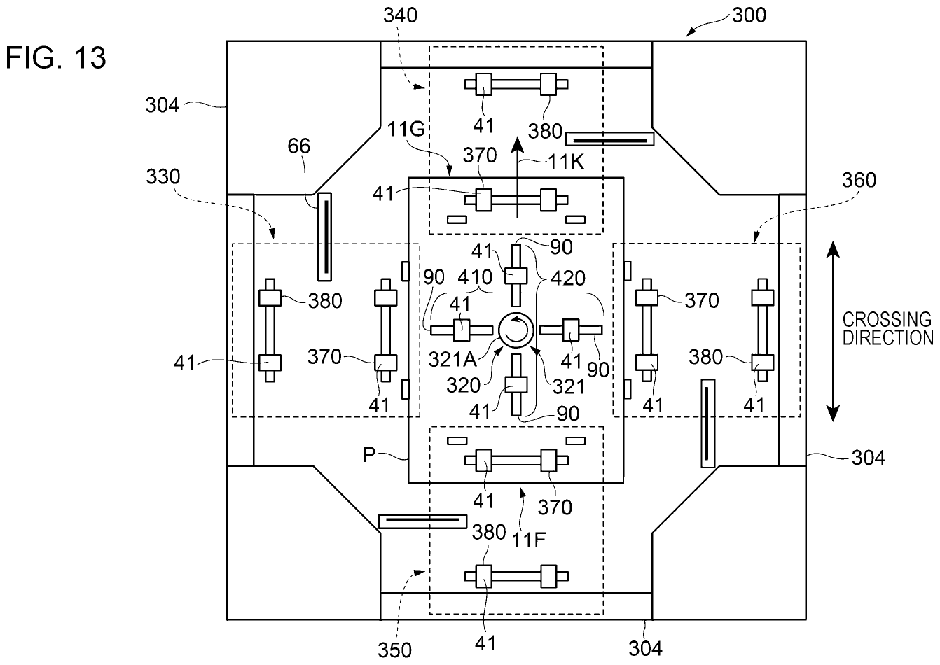

Then, in the present exemplary embodiment, the rotating mechanism 320 is driven in response to an instruction from the CPU 11a, and the paper P is rotated, as illustrated in FIG. 13.

To drive the rotating mechanism 320, first, the upper rotating body 321A advances toward the lower rotating body 321B (not illustrated in FIG. 13). The paper P is thus held by the rotating body 321.

After the paper P is held by the rotating body 321, the upper transport member 41 provided in the first movement mechanism 410 retreats from the lower transport member 42 (not illustrated in FIG. 13), and the upper transport member 41 is separated away from the lower transport member 42.

Then, the rotating body 321 is rotated. This rotates the paper P, thereby changing an orientation of the paper P.

In the present exemplary embodiment, the contact part 45 (see FIG. 6A) between the upper transport member 41 and the lower transport member 42 (not illustrated in FIG. 13) that are provided in each of the central side transport members 370 is closer to the lower guide member 502 than the midpoint 76A of the straight line 76 connecting the upper guide member 501 (see FIG. 6A) and the lower guide member 502, as described above.

Furthermore, the contact part 45 (see FIG. 9A) between the upper transport member 41 and the lower transport member 42 (not illustrated in FIG. 13) that are provided in each of the first movement mechanism 410 (see FIG. 13) and the second movement mechanisms 420 is closer to the lower guide member 502 than the midpoint 76A of the straight line 76 connecting the upper guide member 501 (see FIG. 9A) and the lower guide member 502, as described above.

In this case, the distance L1 (see FIGS. 6B and 9B) between the paper guide surface 501A of the upper guide member 501 and the lower transport member 42 is large in a state where the upper transport member 41 has retreated from the lower transport member 42, as described above.

In this case, resistance acting from the upper guide member 501 and the lower transport member 42 on the paper P that is rotating as illustrated in FIG. 13 is small. In this case, a load on the rotating paper P is small.

In the present exemplary embodiment, when the paper P is rotated, the paper P moves between the upper guide member 501 (not illustrated in FIG. 13) and the lower transport member 42 (not illustrated in FIG. 13) that are provided in each of the pre-rotation transport mechanism 330, the first post-rotation transport mechanism 340, the second post-rotation transport mechanism 350, and the downstream side transport mechanism 360, as illustrated in FIG. 13.

Furthermore, when the paper P is rotated, the paper P moves between the upper guide member 501 (not illustrated in FIG. 13) and the lower transport member 42 (not illustrated in FIG. 13) that are provided in each of the first movement mechanism 410 and the second movement mechanism 420.

In the present exemplary embodiment, during the rotation, the distance L1 between the upper guide member 501 and the lower transport member 42 is large, and a load on the rotating paper P is small, as described above.

Note that in the present exemplary embodiment, when the paper P is rotated, the paper P does not pass between the upper transport member 41 and the lower transport member 42 (not illustrated in FIG. 13) that constitute the side wall side transport member 380 provided in each of the pre-rotation transport mechanism 330, the first post-rotation transport mechanism 340, the second post-rotation transport mechanism 350, and the downstream side transport mechanism 360, as illustrated in FIG. 13.

The CPU 11a (see FIG. 3) that constitutes a part of a rotator sets an amount by which the paper P is rotated by the rotating mechanism 320 (see FIG. 13).

In a case where the paper P is not inclined and a posture of the paper P transported to the rotating mechanism 320 by the pre-rotation transport mechanism 330 is straight, the CPU 11a sets the amount of rotation of the paper P to 90° and rotates the paper P by 90 degrees in a counterclockwise direction.

On the other hand, in a case where the paper P transported to the rotating mechanism 320 by the pre-rotation transport mechanism 330 is inclined with respect to the transport direction in which the paper P is transported by the pre-rotation transport mechanism 330 as illustrated in FIG. 10, the CPU 11a increases or decreases the amount of rotation of the paper P in accordance with the inclination of the paper P.

In the present exemplary embodiment, the CPU 11a specifies the inclination of the paper P on the basis of outputs from the first paper detection sensor 67A and the second paper detection sensor 67B when the paper P is transported to the rotating mechanism 320 by the pre-rotation transport mechanism 330 (see FIG. 10).

The CPU 11a increases or decreases the amount of rotation of the paper P on the basis of the specified inclination.

In the present exemplary embodiment, in a case where the paper P is inclined, a timing at which the paper P is detected by the first paper detection sensor 67A and a timing at which the paper P is detected by the second paper detection sensor 67B are difference, as described above.

The CPU 11a specifies the inclination of the paper P on the basis of a time difference between these two timings.

In the present exemplary embodiment, a relationship table describing a relationship between the time difference and a correction value of a rotation amount is registered in the secondary storage unit 19 (see FIG. 3).

When the CPU 11a obtains the time difference between the two timings, the CPU 11a acquires a correction value of a rotation amount by referring to the relationship table. The CPU 11a increases or decreases the amount of rotation of the paper P on the basis of the specified correction value.

In other words, the CPU 11a sets a new rotation amount on the basis of the acquired correction value and 90°, which is a predetermined rotation amount.

Note that in the present exemplary embodiment, in a case where the time difference between the two timings is smaller than a predetermined threshold value and the inclination of the paper P is small, the amount of rotation of the paper P is not corrected.

In this case, the amount of rotation of the paper P is not increased nor decreased, and the amount of rotation of the paper P is 90°, which is the predetermined rotation amount.

The CPU 11a makes the amount of rotation of the paper P smaller than the predetermined rotation amount in a case where the paper P is inclined so that the leading end portion 11G in the transport direction in which the paper P is transported to the rotating mechanism 320 by the pre-rotation transport mechanism 330 is directed toward a downstream side in the direction in which the paper P is rotated by the rotating mechanism 320 as indicated by arrow 10E in FIG. 10.

In the present exemplary embodiment, the paper P is rotated in a counterclockwise direction by the rotating mechanism 320.

The CPU 11a makes the amount of rotation of the paper P smaller than the predetermined rotation amount in a case where the leading end portion 11G in the transport direction in which the paper P is transported does not directly face the downstream side transport mechanism 360 and is directed toward the downstream side in the counterclockwise direction in which the paper P is rotated by the rotating mechanism 320.

More specifically, in a case where the leading end portion 11G in the transport direction is directed toward the side where the first post-rotation transport mechanism 340 is located, the CPU 11a makes the amount of rotation of the paper P smaller than the predetermined rotation amount.

In this case, the CPU 11a sets the rotation amount to a value smaller than the 90 degrees.

As described above, the CPU 11a acquires a correction value of a rotation angle on the basis of the time difference between the two timings. In a case where the leading end portion 11G in the transport direction is directed toward the side where the first post-rotation transport mechanism 340 is located, the correction value is a negative value.

The CPU 11a obtains a corrected new rotation amount by adding the negative value to 90°.

The CPU 11a makes the amount of rotation of the paper P larger than the predetermined rotation amount in a case where the paper P is inclined so that the leading end portion 11G in the transport direction in which the paper P is transported to the rotating mechanism 320 by the pre-rotation transport mechanism 330 is directed toward an upstream side in the direction in which the paper P is rotated by the rotating mechanism 320.

Specifically, the CPU 11a makes the amount of rotation of the paper P larger than the predetermined rotation amount in a case where the leading end portion 11G in the transport direction in which the paper P is transported does not directly face the downstream side transport mechanism 360 and is directed toward the upstream side in the counterclockwise direction in which the paper P is rotated by the rotating mechanism 320.

More specifically, in a case where the leading end portion 11G in the transport direction is directed toward the side where the second post-rotation transport mechanism 350 is located, the CPU 11a makes the amount of rotation of the paper P larger than the predetermined rotation amount. In this case, the CPU 11a sets the rotation amount to a value larger than the 90 degrees.

As described above, the CPU 11a acquires a correction value of a rotation angle on the basis of the time difference between the two timings. In a case where the leading end portion 11G in the transport direction is directed toward the side where the second post-rotation transport mechanism 350 is located, the correction value is a positive value.

The CPU 11a obtains a corrected new rotation amount by adding the positive value to 90°.

As described above, in the present exemplary embodiment, the amount of rotation of the paper P is increased or decreased in accordance with the orientation of the paper P. By thus increasing or decreasing the amount of rotation, the leading end portion 11G of the rotated paper P faces the first post-rotation transport mechanism 340, as indicated by arrow 11K of FIG. 13.

In the present exemplary embodiment, after the paper P is rotated, the upper transport member 41 provided in the first movement mechanism 410 (see FIG. 13) advances toward the lower transport member 42 (not illustrated in FIG. 13).

The paper P is thus sandwiched between the upper transport member 41 and the lower transport member 42 that are provided in the first movement mechanism 410.

Then, in the present exemplary embodiment, the upper rotating body 321A retreats from the lower rotating body 321B (not illustrated in FIG. 13), and the upper rotating body 321A is thus separated away from the lower rotating body 321B.

Furthermore, in the present exemplary embodiment, the upper transport member 41 that constitutes the central side transport member 370 provided in the first post-rotation transport mechanism 340 advances toward the lower transport member 42 (not illustrated in FIG. 13), and the upper transport member 41 makes contact with the lower transport member 42.

Next, the transport member 90 provided in the first movement mechanism 410 is driven to rotate, and the central side transport member 370 and the side wall side transport member 380 that are provided in the first post-rotation transport mechanism 340 are driven to rotate.

As a result, the paper P located in a place where the rotating body 321 is provided travels toward the fourth paper processing apparatus 400 (see FIG. 2) via the first post-rotation transport mechanism 340.

Note that in the present exemplary embodiment, when a rear end portion 11F (see FIG. 13) of the paper P traveling toward the fourth paper processing apparatus 400 reaches the side wall side transport member 380 provided in the first post-rotation transport mechanism 340, the upper transport member 41 that constitutes the central side transport member 370 provided in the first post-rotation transport mechanism 340 retreats from the lower transport member 42 (not illustrated in FIG. 13).

The upper transport member 41 that constitutes the central side transport member 370 is thus separated away from the lower transport member 42.

Furthermore, when the rear end portion 11F of the paper P traveling toward the fourth paper processing apparatus 400 reaches the side wall side transport member 380 provided in the first post-rotation transport mechanism 340, the upper transport member 41 provided in the first movement mechanism 410 retreats from the lower transport member 42. The upper transport member 41 is thus separated away from the lower transport member 42.

Then, in the present exemplary embodiment, new paper P is transported from the second paper processing apparatus 200 (see FIG. 2) to the rotating mechanism 320 through the pre-rotation transport mechanism 330.

In the present exemplary embodiment, in this state, the upper transport member 41 that constitutes the central side transport member 370 provided in the first post-rotation transport mechanism 340 has already retreated from the lower transport member 42, and the upper transport member 41 provided in the first movement mechanism 410 has already retreated from the lower transport member 42.

In the present exemplary embodiment, when the paper P is rotated by the rotating mechanism 320, the lower transport members 42 that constitutes the transport members 90 provided in each of the first movement mechanism 410 and the second movement mechanism 420 are rotated.

Furthermore, when the paper P is rotated by the rotating mechanism 320, the lower transport member 42 that constitutes the central side transport member 370 provided in each of the pre-rotation transport mechanism 330, the first post-rotation transport mechanism 340, the second post-rotation transport mechanism 350, and the downstream side transport mechanism 360 is rotated.

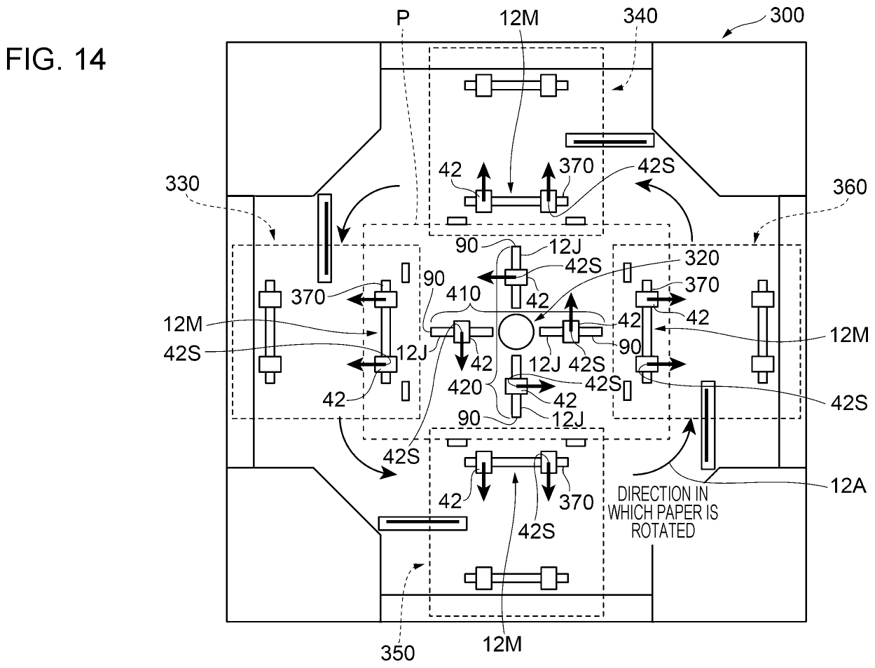

FIG. 14 illustrates a state of rotation of the lower transport member 42 during rotation of the paper P. In FIG. 14, illustration of the upper transport member 41 is omitted.

In the present exemplary embodiment, when the paper P is rotated, the lower transport members 42 that constitute the transport members 90 provided in each of the first movement mechanism 410 and the second movement mechanism 420 are rotated, as described above.

Furthermore, when the paper P is rotated, the lower transport member 42 that constitutes the central side transport member 370 provided in each of the pre-rotation transport mechanism 330, the first post-rotation transport mechanism 340, the second post-rotation transport mechanism 350, and the downstream side transport mechanism 360 is rotated.

In the present exemplary embodiment, when the paper P is rotated in the counterclockwise direction by the rotating mechanism 320, the lower transport members 42 that make contact with the lower surface PD (not illustrated in FIG. 14) of the rotating paper P among the plural lower transport members 42 are rotated, as illustrated in FIG. 14.

Hereinafter, the paper P that is being rotated by the rotating mechanism 320 is sometimes referred to as “rotating paper P”.

Four lower transport members 42 indicated by reference sign 12J that are located around the rotating mechanism 320 are rotated so that contact portions 42S thereof that make contact with the rotating paper P move toward the downstream side in the direction in which the rotating paper P is rotated.

Specifically, in the present exemplary embodiment, each of the lower transport members 42 provided in the first movement mechanism 410 and the second movement mechanism 420 is rotated so that the contact portion 42S that makes contact with the rotating paper P moves toward the downstream side in the direction in which the rotating paper P is rotated.

Furthermore, in the present exemplary embodiment, the four lower transport members 42 indicated by reference signs 12M are rotated so that contact portions 42S thereof that make contact with the rotating paper P move toward a side opposite to the side where the rotating mechanism 320 is provided.

Each of the four lower transport members 42 indicated by reference signs 12M constitutes the central side transport member 370 provided in each of the pre-rotation transport mechanism 330, the first post-rotation transport mechanism 340, the second post-rotation transport mechanism 350, and the downstream side transport mechanism 360.

Each lower transport member 42 that constitutes the central side transport member 370 is rotated so that the contact portion 42S that makes contact with the rotating paper P moves toward the side opposite to the side where the rotating mechanism 320 is provided.

In a case where the contact portion 42S that makes contact with the rotating paper P moves toward the side opposite to the side where the rotating mechanism 320 is provided, force acting to pull the paper P acts on the paper P. In this case, warp or the like of the paper P is less likely to occur than a case where force acting in a direction opposite to the pulling direction acts on the paper P.

Note that although a velocity of rotation of the lower transport member 42 is not limited in particular, a circumferential velocity of the lower transport member 42 provided in each of the first movement mechanism 410 and the second movement mechanism 420 is desirably set higher than a movement velocity of a portion of the paper P that makes contact with the lower transport member 42.

This increases force for rotating the paper P that acts on the paper P from the lower transport member 42 provided in each of the first movement mechanism 410 and the second movement mechanism 420, thereby allowing the paper P to more smoothly rotate.

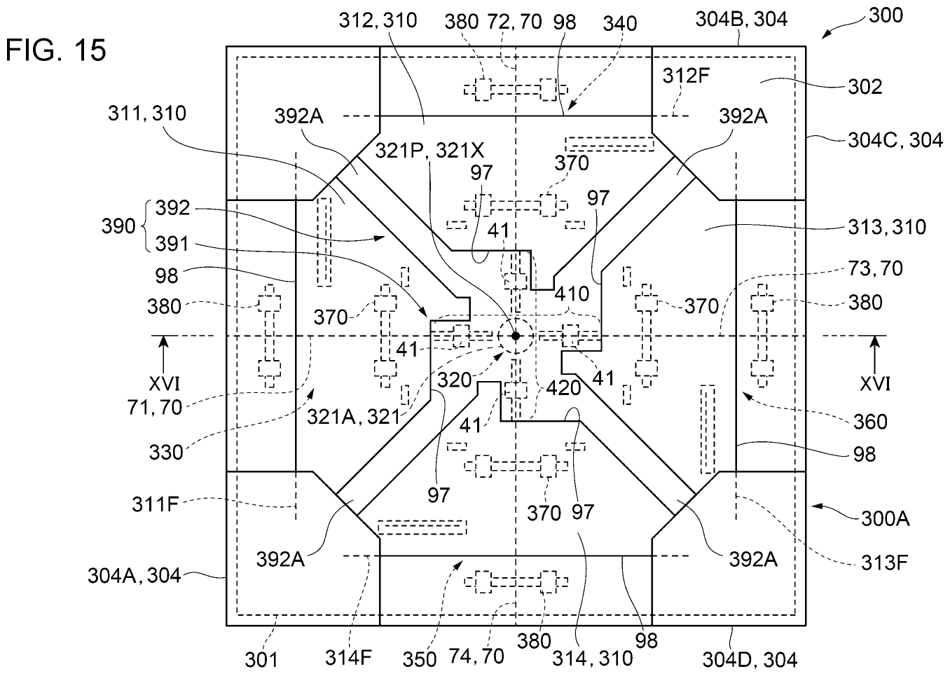

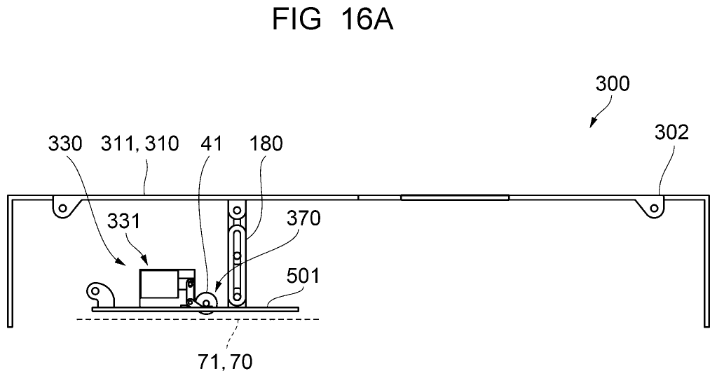

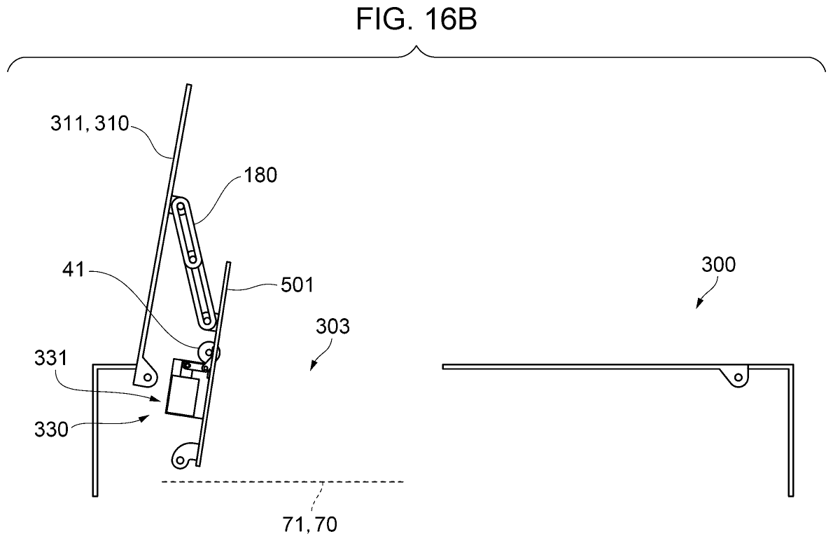

FIG. 15 illustrates the third paper processing apparatus 300 viewed from above. FIGS. 16A and 16B are cross-sectional views of the third paper processing apparatus 300 taken along line XVI-XVI of FIG. 15. FIGS. 16A and 16B illustrate a state of a cross section in a place where the pre-rotation transport mechanism 330 is provided.

In the present exemplary embodiment, the opening and closing member 310 is provided in the upper surface 302 of the third paper processing apparatus 300, as illustrated in FIGS. 1 and 15.

The opening and closing member 310 also serves as an exterior member of the third paper processing apparatus 300. A surface of the opening and closing member 310 that is opposite to a surface facing the processing unit 301 is exposed, and thus the opening and closing member 310 also serves as an exterior member.

The opening and closing member 310 also serves as a covering member. The opening and closing member 310 covers an upper portion of a space where the processing unit 301 is accommodated that is located in an upper portion of the third paper processing apparatus 300.

In the present exemplary embodiment, first opening and closing member 311 to fourth opening and closing member 314 are provided as the opening and closing member 310.

Furthermore, a support member 390 is provided on the upper surface 302 of the third paper processing apparatus 300. The support member 390 also serves as an exterior member since a surface thereof opposite to a surface facing the processing unit 301 is exposed.

The support member 390 supports the upper transport members 41 provided in the first movement mechanism 410 and the second movement mechanism 420 and the advancing/retreating mechanisms 331 (see FIGS. 9A and 9B) that advance and retreat the upper transport members 41.

Furthermore, the support member 390 supports the upper rotating body 321A provided in the rotating mechanism 320 and the advancing/retreating mechanism 322 (see FIG. 5) that advances and retreats the upper rotating body 321A.

Furthermore, the support member 390 supports the upper guide member 501 (not illustrated in FIG. 15) (see FIGS. 5 and 9) that is provided in the rotating mechanism 320, the first movement mechanism 410, and the second movement mechanism 420.

On the other hand, the lower transport members 42 (not illustrated in FIG. 15) provided in the first movement mechanism 410 and the second movement mechanism 420, the lower rotating body 321B (see FIG. 5) provided in the rotating mechanism 320, and the drive mechanism 323 (see FIG. 5) that rotates the lower rotating body 321B are supported by a portion of the apparatus body 300A that is located below the processing unit 301.

The lower guide member 502 (not illustrated in FIG. 15) (see FIGS. 5 and 9) that is provided in the rotating mechanism 320, the first movement mechanism 410, and the second movement mechanism 420 is also supported by the portion of the apparatus body 300A that is located below the processing unit 301.

The support member 390 has an X shape.

The support member 390 includes a central portion 391 located in a central portion of the third paper processing apparatus 300 and plural protruding portions 392 that protrude from the central portion 391 and extend radially. In the present exemplary embodiment, four protruding portions 392 are provided.

The support member 390 is supported by the apparatus body 300A of the third paper processing apparatus 300. Specifically, in the present exemplary embodiment, leading end portions 392A of the four protruding portions 392 are connected to the apparatus body 300A, and thereby the support member 390 is supported by the apparatus body 300A.

The upper transport members 41 provided in the first movement mechanism 410 and the second movement mechanism 420 and the upper rotating body 321A provided in the rotating mechanism 320 are located below the support member 390 in a vertical direction.

The upper transport members 41 provided in the first movement mechanism 410 and the second movement mechanism 420 and the upper rotating body 321A are supported by the support member 390 that is located above these members.

The advancing/retreating mechanism 322 (see FIG. 5) that advances and retreats the upper rotating body 321A is also supported by the support member 390 located above the advancing/retreating mechanism 322.

The advancing/retreating mechanisms 331 (see FIGS. 9A and 9B) that advance and retreat the upper transport members 41 provided in the first movement mechanism 410 and the second movement mechanism 420 are also supported by the support member 390 located above the advancing/retreating mechanisms 331.

Furthermore, the upper guide member 501 (see FIGS. 5 and 9) provided in the rotating mechanism 320, the first movement mechanism 410, and the second movement mechanism 420 is also supported by the support member 390 located above the upper guide member 501.

The support member 390 is located above the processing unit 301.

The support member 390 supports, from an upper side, the upper guide member 501, the upper rotating body 321A, the advancing/retreating mechanism 322 that advances and retreats the upper rotating body 321A, the upper transport member 41, and the advancing/retreating mechanism 331 that advances and retreats the upper transport member 41 that constitute parts of the processing unit 301.

In a case where the third paper processing apparatus 300 is viewed from above, the third paper processing apparatus 300 has a rectangular shape.

The third paper processing apparatus 300 includes, in an outer circumferential portion thereof, first side wall 304A to fourth side wall 304D as the side wall 304, and the first side wall 304A to fourth side wall 304D are located at different positions in a circumferential direction of the third paper processing apparatus 300.

The first side wall 304A and the third side wall 304C extend along a direction orthogonal to the transport direction in which the paper P is transported from the second paper processing apparatus 200 (see FIG. 2).

The second side wall 304B and the fourth side wall 304D extend along the transport direction in which the paper P is transported from the second paper processing apparatus 200.

The first side wall 304A is disposed at a position facing the second paper processing apparatus 200, and the second side wall 304B is disposed at a position facing the fourth paper processing apparatus 400 (see FIG. 2).

The third side wall 304C is disposed at a position facing the fifth paper processing apparatus 500 (see FIG. 2), and the fourth side wall 304D is disposed at a position facing the sixth paper processing apparatus 600 (see FIG. 2).

The first opening and closing member 311 to fourth opening and closing member 314 are disposed around the central portion 391 of the support member 390.

The first opening and closing member 311 to fourth opening and closing member 314 are arranged at constant intervals in a circumferential direction of the central portion 391 of the support member 390.

The first opening and closing member 311 to fourth opening and closing member 314 are disposed so that positions thereof in the direction in which the rotating body 321 is rotated are different, and are arranged at constant intervals in the direction in which the rotating body 321 is rotated.

Furthermore, the first opening and closing member 311 to fourth opening and closing member 314 are provided at positions deviated from a rotation center 321P of the rotating body 321.

Furthermore, in the present exemplary embodiment, a distance between the first opening and closing member 311 and the rotation center 321P, a distance between the second opening and closing member 312 and the rotation center 321P, a distance between the third opening and closing member 313 and the rotation center 321P, and a distance between the fourth opening and closing member 314 and the rotation center 321P are equal.

In the present exemplary embodiment, plural transport paths 70 along which the paper P passes extend radially about the place where the rotating body 321 is provided, which is an example of a predetermined place.

In the present exemplary embodiment, a first transport path 71 that extends from the rotation center 321P of the rotating body 321 to the pre-rotation transport mechanism 330 and passes through the pre-rotation transport mechanism 330 is provided as one of the plural transport paths 70.

In the present exemplary embodiment, a second transport path 72 that extends from the rotation center 321P of the rotating body 321 to the first post-rotation transport mechanism 340 and passes through the first post-rotation transport mechanism 340 is provided.

In the present exemplary embodiment, a third transport path 73 that extends from the rotation center 321P of the rotating body 321 to the downstream side transport mechanism 360 and passes through the downstream side transport mechanism 360 is provided.

In the present exemplary embodiment, a fourth transport path 74 that extends from the rotation center 321P of the rotating body 321 to the second post-rotation transport mechanism 350 and passes through the second post-rotation transport mechanism 350 is provided.

In the present exemplary embodiment, the paper P transported by the pre-rotation transport mechanism 330 passes along the first transport path 71, and the paper P transported by the first post-rotation transport mechanism 340 passes along the second transport path 72.

In the present exemplary embodiment, the paper P transported by the downstream side transport mechanism 360 passes along the third transport path 73, and the paper P transported by the second post-rotation transport mechanism 350 passes along the fourth transport path 74.

The plural transport paths 70 including the first transport path 71 to fourth transport path 74 are provided in the apparatus body 300A.

The plural transport paths 70 radially extend about the rotation center 321P of the rotating body 321. In other words, the plural transport paths 70 radially extend from the rotation center 321P.

The plural transport paths 70 extend from the place where the rotating body 321 is provided toward the side wall 304 of the third paper processing apparatus 300.

The plural transport paths 70 radially extend about the rotation center 321P of the rotating body 321 away from the rotation center 321P.

Note that the aspect in which “the plural transport paths 70 radially extend” is not limited to an aspect in which the transport path 70 is provided at constant angles, such as an aspect in which the transport path 70 is provided every 90° in the direction in which the rotating body 321 is rotated.

The aspect in which “the plural transport paths 70 radially extend” is not limited to an aspect in which an angle between each pair of transport paths 70 adjacent in the direction in which the rotating body 321 is rotated is equal to an angle between another pair of transport paths 70.

In the present exemplary embodiment, even an aspect in which an angle between one pair of adjacent transport paths 70 and an angle between another pair of adjacent transport paths 70 are different falls under the aspect in which “the plural transport paths 70 radially extend”.

In the present exemplary embodiment, the opening and closing member 310 is provided above each of the transport paths 70. In the present exemplary embodiment, the opening and closing member 310 is provided corresponding to each of the transport paths 70.

Specifically, in the present exemplary embodiment, the first opening and closing member 311 is provided above the first transport path 71, and the second opening and closing member 312 is provided above the second transport path 72.

In the present exemplary embodiment, the third opening and closing member 313 is provided above the third transport path 73, and the fourth opening and closing member 314 is provided above the fourth transport path 74.

In the present exemplary embodiment, the first opening and closing member 311 corresponds to the first transport path 71, the second opening and closing member 312 corresponds to the second transport path 72, the third opening and closing member 313 corresponds to the third transport path 73, and the fourth opening and closing member 314 corresponds to the fourth transport path 74.

In the present exemplary embodiment, the opening and closing member 310 is provided corresponding to each of the individual transport paths 70 included in the plural transport paths 70. In the present exemplary embodiment, each opening and closing member 310 is provided at a position facing a corresponding transport path 70.

In the present exemplary embodiment, the plural opening and closing members 310 are disposed so that positions thereof in a circumferential direction of the plural transport paths 70 that are radially provided are different.

In other words, the plural opening and closing members 310 are disposed so that positions thereof in a direction in which the plural transport paths 70 that are radially provided are arranged are different.

In the present exemplary embodiment, the plural opening and closing members 310 are disposed at positions deviated from a line extended from the rotary axis 321X of the rotating body 321.

The plural opening and closing members 310 are disposed so that positions thereof in the direction in which the rotating body 321 is rotated are different.

In the present exemplary embodiment, each opening and closing member 310 is provided between adjacent ones of the plural protruding portions 392 that constitute the support member 390.

The first opening and closing member 311 to fourth opening and closing member 314 are attached to the apparatus body 300A so as to be rotatable with respect to the apparatus body 300A.

In the present exemplary embodiment, the first opening and closing member 311 is provided between the first side wall 304A and the central portion 391 of the support member 390. The second opening and closing member 312 is provided between the second side wall 304B and the central portion 391 of the support member 390.

The third opening and closing member 313 is provided between the third side wall 304C and the central portion 391 of the support member 390. The fourth opening and closing member 314 is provided between the fourth side wall 304D and the central portion 391 of the support member 390.

In the present exemplary embodiment, in a case where the third paper processing apparatus 300 is viewed from above, the first opening and closing member 311 is provided between the first side wall 304A and the rotation center 321P of the rotating body 321, as illustrated in FIG. 15.

The second opening and closing member 312 is provided between the second side wall 304B and the rotation center 321P of the rotating body 321. The third opening and closing member 313 is provided between the third side wall 304C and the rotation center 321P of the rotating body 321. The fourth opening and closing member 314 is provided between the fourth side wall 304D and the rotation center 321P of the rotating body 321.

In the present exemplary embodiment, the first opening and closing member 311 rotates about a rotary axis 311F extending along the first side wall 304A.

The rotary axis 311F is provided at an opposite end portion 98 opposite to a central side end portion 97 that is an end portion of the first opening and closing member 311 that is located close to the central portion 391 of the support member 390.

The first opening and closing member 311 includes the central side end portion 97, which is an example of a first end portion located close to the place where the rotating body 321 is provided, and the opposite end portion 98, which is an example of a second end portion located on a side opposite to the central side end portion 97.

The opposite end portion 98 of the first opening and closing member 311 is provided with a hinge (not illustrated), and this hinge is provided on the rotary axis 311F.

The first opening and closing member 311 rotates about the rotary axis 311F.

In the present exemplary embodiment, the rotary axis 311F is provided on a side where the opposite end portion 98 of the first opening and closing member 311 is provided.

The rotary axis 311F extends in a direction crossing a direction in which the first transport path 71 corresponding to the first opening and closing member 311 extends. More specifically, the rotary axis 311F extends in a direction orthogonal to the direction in which the first transport path 71 extends.

In the present exemplary embodiment, the first opening and closing member 311 is rotatable about the rotary axis 311F extending in a direction crossing the direction in which the first transport path 71 corresponding to the first opening and closing member 311 extends.

In the present exemplary embodiment, in a case where widths of the first opening and closing member 311 in a direction orthogonal to the direction in which the first transport path 71 extends are compared, a width of the opposite end portion 98 of the first opening and closing member 311 is larger than a width of the central side end portion 97 of the first opening and closing member 311.

In the present exemplary embodiment, the first opening and closing member 311 is configured so that a width thereof gradually increases from the central side end portion 97 toward the opposite end portion 98.

The rotary axis 311F of the first opening and closing member 311 extends in a direction crossing the transport direction in which the paper P is transported by the pre-rotation transport mechanism 330. More specifically, the rotary axis 311F extends in a direction orthogonal to the transport direction in which the paper P is transported by the pre-rotation transport mechanism 330. The first opening and closing member 311 rotates about the rotary axis 311F.

When a user rotates the first opening and closing member 311 about the rotary axis 311F, the first opening and closing member 311 is opened, and the third paper processing apparatus 300 shifts to the state illustrated in FIG. 1.

To open the first opening and closing member 311, the user lifts up the central side end portion 97 side of the first opening and closing member 311. This rotates the first opening and closing member 311 about the rotary axis 311F, shifting the first opening and closing member 311 to the state illustrated in FIG. 1.

As a result, in the present exemplary embodiment, a portion above the processing unit 301 (see FIG. 1) where the first opening and closing member 311 was present is opened, and the opening 303 is formed in this portion.

The user accesses the first transport path 71 (see FIG. 15) and the rotating mechanism 320 through the opening 303.

In the present exemplary embodiment, the user may touch the paper P located on the first transport path 71 included in the plural transport paths 70 through the opening 303 created by opening the first opening and closing member 311.

Furthermore, in the present exemplary embodiment, the user may touch the paper P at a position facing the rotating body 321 (see FIG. 15) through the opening 303 created by opening the first opening and closing member 311. In other words, the user may touch the paper P located between the upper rotating body 321A (see FIG. 5) and the lower rotating body 321B that constitute the rotating body 321.

In the present exemplary embodiment, the user may touch the paper P located on the first transport path 71 and the paper P at a position facing the rotating body 321 through the one common opening 303 created by opening the first opening and closing member 311.

The second opening and closing member 312 (see FIG. 15) rotates about a rotary axis 312F extending along the second side wall 304B.

The rotary axis 312F is provided at an opposite end portion 98 of the second opening and closing member 312 that is opposite to a central side end portion 97 located close to the central portion 391 of the support member 390.

The rotary axis 312F extends in a direction crossing the transport direction in which the paper P is transported by the first post-rotation transport mechanism 340. More specifically, the rotary axis 312F extends in a direction orthogonal to the transport direction in which the paper P is transported by the first post-rotation transport mechanism 340.

The second opening and closing member 312 rotates about the rotary axis 312F extending in a direction crossing the transport direction in which the paper P is transported by the first post-rotation transport mechanism 340. More specifically, the second opening and closing member 312 rotates about the rotary axis 312F extending in a direction orthogonal to the transport direction in which the paper P is transported by the first post-rotation transport mechanism 340.

When the user rotates the second opening and closing member 312 about the rotary axis 312F, a portion above the processing unit 301 where the second opening and closing member 312 was present is opened, and the opening 303 is formed in this portion. The user accesses the second transport path 72 and the rotating mechanism 320 through the opening 303.

The third opening and closing member 313 rotates about the rotary axis 313F extending along the third side wall 304C. The rotary axis 313F is provided at an opposite end portion 98 of the third opening and closing member 313 that is opposite to a central side end portion 97 located close to the central portion 391 of the support member 390.

The rotary axis 313F extends in a direction crossing the transport direction in which the paper P is transported by the downstream side transport mechanism 360. More specifically, the rotary axis 313F extends in a direction orthogonal to the transport direction in which the paper P is transported by the downstream side transport mechanism 360.

The third opening and closing member 313 rotates about the rotary axis 313F extending in a direction crossing the transport direction in which the paper P is transported by the downstream side transport mechanism 360. More specifically, the third opening and closing member 313 rotates about the rotary axis 313F extending in a direction orthogonal to the transport direction in which the paper P is transported by the downstream side transport mechanism 360.

When the rotary axis 313F is rotated about the rotary axis 313F, a portion above the processing unit 301 where the third opening and closing member 313 was present is opened, and the opening 303 is formed in this portion. The user accesses the third transport path 73 and the rotating mechanism 320 through the opening 303.

The fourth opening and closing member 314 rotates about the rotary axis 314F extending along the fourth side wall 304D. The rotary axis 314F is provided at an opposite end portion 98 of the fourth opening and closing member 314 that is opposite to a central side end portion 97 located close to the central portion 391 of the support member 390.

The rotary axis 314F extends in a direction crossing the transport direction in which the paper P is transported by the second post-rotation transport mechanism 350. More specifically, the rotary axis 314F extends in a direction orthogonal to the transport direction in which the paper P is transported by the second post-rotation transport mechanism 350.

The fourth opening and closing member 314 rotates about the rotary axis 314F extending in a direction crossing the transport direction in which the paper P is transported by the second post-rotation transport mechanism 350. More specifically, the fourth opening and closing member 314 rotates about the rotary axis 314F extending in a direction orthogonal to the transport direction in which the paper P is transported by the second post-rotation transport mechanism 350.

When the fourth opening and closing member 314 is rotated about the rotary axis 314F, a portion above the processing unit 301 where the fourth opening and closing member 314 was present is opened, and the opening 303 is formed in this portion. The user accesses the fourth transport path 74 and the rotating mechanism 320 through the opening 303.

In the present exemplary embodiment, when the first opening and closing member 311 to fourth opening and closing member 314 are opened, not only the first transport path 71 to fourth transport path 74 may be accessed, but also the rotating mechanism 320 may be accessed.

In the present exemplary embodiment, opening any of the first opening and closing member 311 to fourth opening and closing member 314 allows the user to access the rotating mechanism 320.

In the present exemplary embodiment, the first opening and closing member 311 to fourth opening and closing member 314 are provided as the opening and closing member 310 around the rotating mechanism 320, and opening any of the opening and closing members 310 allows the user to access the rotating mechanism 320.

In the present exemplary embodiment, jam of the paper P or the like may undesirably occur in the processing unit 301. In this case, the user removes the jammed paper P through the opening 303 created by opening one opening and closing member 310 or two or more opening and closing members 310 among the first opening and closing member 311 to fourth opening and closing member 314.

During maintenance of the processing unit 301 or the like, the maintenance of the processing unit 301 is performed through the opening 303 created by opening the first opening and closing member 311 to fourth opening and closing member 314.

Furthermore, in the present exemplary embodiment, the opening and closing member 310 is provided above each of the plural central side transport members 370.

In the present exemplary embodiment, the central side transport member 370 is provided in each of the pre-rotation transport mechanism 330, the first post-rotation transport mechanism 340, the second post-rotation transport mechanism 350, and the downstream side transport mechanism 360, as described above.

In the present exemplary embodiment, the opening and closing member 310 is provided above each central side transport member 370.

Specifically, in the present exemplary embodiment, the first opening and closing member 311 is provided above the central side transport member 370 provided in the pre-rotation transport mechanism 330, and the second opening and closing member 312 is provided above the central side transport member 370 provided in the first post-rotation transport mechanism 340.

The third opening and closing member 313 is provided above the central side transport member 370 provided in the downstream side transport mechanism 360, and the fourth opening and closing member 314 is provided above the central side transport member 370 provided in the second post-rotation transport mechanism 350.

In the present exemplary embodiment, a connecting member 180 that connects the first opening and closing member 311 and the upper guide member 501 located below the first opening and closing member 311 is provided, as illustrated in FIGS. 16A and 16B.

In the present exemplary embodiment, the upper transport member 41 that constitutes the central side transport member 370 and the advancing/retreating mechanism 331 that advances and retreats this upper transport member 41 are supported from below by the upper guide member 501, as described above and as illustrated in FIGS. 16A and 16B.

The connecting member 180 connects the first opening and closing member 311 and the upper guide member 501 that has a function of supporting the upper transport member 41 and the advancing/retreating mechanism 331.

In the present exemplary embodiment, when the user opens the first opening and closing member 311, the upper guide member 501 is pulled by the connecting member 180 and the upper guide member 501 moves upward, as illustrated in FIG. 16B.

In the present exemplary embodiment, when the user opens the first opening and closing member 311, the upper guide member 501, which is an example of a side member provided beside the first transport path 71, moves along with the first opening and closing member 311 away from the first transport path 71.

The first transport path 71 is a transport path corresponding to the first opening and closing member 311. In the present exemplary embodiment, when the user opens the first opening and closing member 311, the upper guide member 501 provided beside the transport path 71 corresponding to the first opening and closing member 311 moves.

The upper guide member 501, which is an example of a side member, is provided beside the first transport path 71. The upper guide member 501 guides the paper P passing along the first transport path 71.

In the present exemplary embodiment, when the user opens the first opening and closing member 311, the upper guide member 501 moves along with the first opening and closing member 311 away from the first transport path 71.

Accordingly, in the present exemplary embodiment, the upper transport member 41 provided in the pre-rotation transport mechanism 330 and the advancing/retreating mechanism 331 that advances and retreats the upper transport member 41 move upward, as illustrated in FIG. 16B.

As a result, in the present exemplary embodiment, the first transport path 71 provided between the upper guide member 501 and the lower guide member 502 (not illustrated in FIG. 16B) is exposed, as illustrated in FIG. 16B.

In the present exemplary embodiment, when the user opens the first opening and closing member 311, the user may access the first transport path 71 provided below the first opening and closing member 311.

Note that the second opening and closing member 312 (see FIG. 15) to fourth opening and closing member 314 have similar configurations, and connecting members 180 (not illustrated) corresponding to the second opening and closing member 312 to fourth opening and closing member 314 are provided.

When the user opens any of the second opening and closing member 312 to fourth opening and closing member 314, a similar action to a case where the first opening and closing member 311 is opened is performed, and the user may access a corresponding one of the second transport path 72 to fourth transport path 74.

Note that the rotating body 321 (see FIG. 15) is supported by a member other than the opening and closing member 310 among members that constitute the third paper processing apparatus 300. The rotating body 321 is supported by an unmovable member.

Specifically, in the present exemplary embodiment, the upper rotating body 321A that constitutes the rotating body 321 is supported by a support member 390, which is an example of the unmovable member.

In the present exemplary embodiment, the lower rotating body 321B (not illustrated in FIG. 15) that constitutes the rotating body 321 is also supported by the apparatus body 300A, which is another example of the unmovable member.

In a case where the user accesses the processing unit 301 provided in the third paper processing apparatus 300, the user is located in any of four positions indicated by reference sign 2X of FIG. 2.

Specifically, the user is located at any of positions facing first corner portion 191 to fourth corner portion 194, which are four corner portions of the third paper processing apparatus 300.

In the present exemplary embodiment, in a case where the user is located at a position facing the first corner portion 191, it is easy for the user to open and close the first opening and closing member 311 and the second opening and closing member 312. In a case where the user is located at a position facing the second corner portion 192, it is easy for the user to open and close the second opening and closing member 312 and the third opening and closing member 313.

In a case where the user is located at a position facing the third corner portion 193, it is easy for the user to open and close the third opening and closing member 313 and the fourth opening and closing member 314. In a case where the user is located at a position facing the fourth corner portion 194, it is easy for the user to open and close the first opening and closing member 311 and the fourth opening and closing member 314.

In the present exemplary embodiment, a configuration in which the rotary axis 311F is provided at the opposite end portion 98, which is one of end portions of the first opening and closing member 311 (see FIG. 15), has been described as an example.

However, this is not restrictive, and the rotary axis 311F may be provided on a side where the central side end portion 97 of the first opening and closing member 311 is provided.

In a case where the rotary axis 311F is provided on the side where the central side end portion 97 of the first opening and closing member 311 is provided, the user opens and closes the first opening and closing member 311 by operating the opposite end portion 98 side of the first opening and closing member 311.

Similarly, the second opening and closing member 312 to fourth opening and closing member 314 may have a configuration in which the rotary axis is provided on the side where the central side end portion 97 is provided.

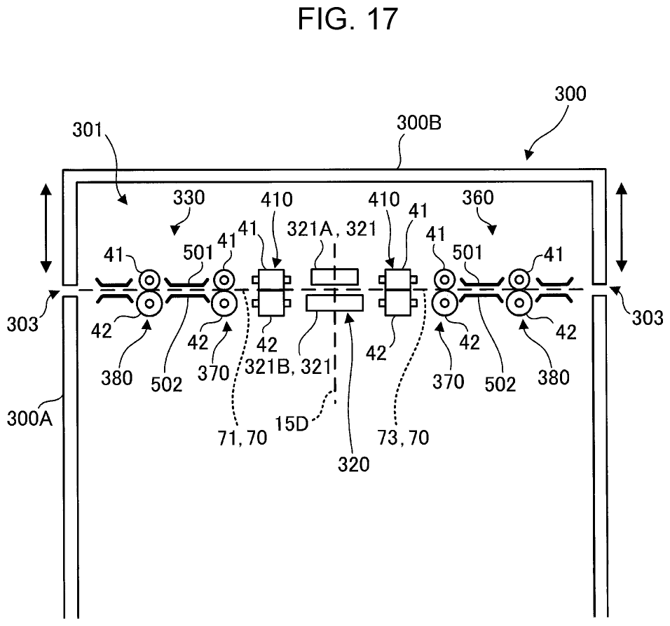

FIG. 17 illustrates another example of the configuration of the third paper processing apparatus 300.

In this example illustrated in FIG. 17, a movable body 300B that moves along the up-down direction is provided above the apparatus body 300A of the third paper processing apparatus 300. The movable body 300B moves relative to the apparatus body 300A.

Note that the configuration of the processing unit 301 provided in the third paper processing apparatus 300 is identical to the configuration described above.

The movable body 300B is movable away from the plural transport paths 70 in a direction in which a central axis 15D of the plural transport paths 70 that extend radially extends. Specifically, the movable body 300B is movable upward in FIG. 17.

In this example, the upper rotating body 321A of the rotating mechanism 320 is supported by the movable body 300B. The advancing/retreating mechanism 322 (not illustrated in FIG. 17) (see FIG. 5) that advances and retreats the upper rotating body 321A is also supported by the movable body 300B.

In this example, the upper transport member 41 that constitutes the central side transport member 370 provided in each of the pre-rotation transport mechanism 330, the first post-rotation transport mechanism 340 (not illustrated in FIG. 17), the second post-rotation transport mechanism 350 (not illustrated in FIG. 17), and the downstream side transport mechanism 360 is also supported by the movable body 300B.

Furthermore, the advancing/retreating mechanism 331 (not illustrated in FIG. 17) (see FIGS. 6A and 6B) provided corresponding to the upper transport member 41 is also supported by the movable body 300B.

In this example, the upper transport member 41 that constitutes the side wall side transport member 380 provided in each of the pre-rotation transport mechanism 330, the first post-rotation transport mechanism 340, the second post-rotation transport mechanism 350, and the downstream side transport mechanism 360 is also supported by the movable body 300B.

In this example, the upper transport member 41 provided in each of the first movement mechanism 410 and the second movement mechanism 420 (not illustrated in FIG. 17) and the advancing/retreating mechanism 331 (not illustrated in FIG. 17) (see FIGS. 9A and 9B) provided corresponding to this upper transport member 41 are also supported by the movable body 300B.

Furthermore, each upper guide member 501 provided in the processing unit 301 is also supported by the movable body 300B.

In this example, members located above the transport path 70 along which the paper P is transported among plural members that constitute the processing unit 301 are supported by the movable body 300B.

In this example, the user moves the movable body 300B upward manually or by using a drive mechanism (not illustrated) such as a motor.

In this example, the upper transport member 41 that constitutes the central side transport member 370 and the advancing/retreating mechanism 331 provided corresponding to this upper transport member 41 move upward.

The upper transport member 41 that constitute the side wall side transport member 380 also moves upward.

Furthermore, the upper transport member 41 provided in each of the first movement mechanism 410 and the second movement mechanism 420 and the advancing/retreating mechanism 331 provided corresponding to this upper transport member 41 also move upward.

Furthermore, the upper guide member 501 and the upper rotating body 321A also move upward. Furthermore, the advancing/retreating mechanism 322 provided corresponding to the upper rotating body 321A also moves upward.

In the present exemplary embodiment, the upper transport member 41, the advancing/retreating mechanism 322, the advancing/retreating mechanism 331, the upper guide member 501, and the upper rotating body 321A are provided as examples of the side member beside the individual transport paths 70 included in the plural transport paths 70 that radially extend.

In the present exemplary embodiment, these members, which are examples of the side member, move away from the transport paths 70 as the movable body 300B moves.

Also in this example, the first transport path 71 to fourth transport path 74 are exposed, and the user may access the first transport path 71 to fourth transport path 74. Furthermore, the user may access the rotating mechanism 320.

In this example illustrated in FIG. 17, the user accesses the processing unit 301 from beside the third paper processing apparatus 300.

In the above example illustrated in FIGS. 1 and 2, the user accesses the processing unit 301 from above the third paper processing apparatus 300 through the opening 303 created in the upper surface 302 of the third paper processing apparatus 300.

On the other hand, in the example illustrated in FIG. 17, the opening 303 is provided in a side portion of the third paper processing apparatus 300. In the example illustrated in FIG. 17, the user accesses the processing unit 301 through the opening 303 provided in the side portion of the third paper processing apparatus 300.

Although the configuration in which all members located above the transport paths 70 move upward has been described as an example, not all members need to move.

For example, it is possible to employ a configuration in which only one or some of the members located above the transport paths 70, for example, only the upper transport member 41 that constitutes the central side transport member 370 and only the upper transport member 41 that constitutes the side wall side transport member 380 move upward and the other members do not move upward.

### Other Remarks

An orientation of the third paper processing apparatus 300 may be changed although description thereof is omitted above. For example, the third paper processing apparatus 300 may be placed so that a side where the downstream side transport mechanism 360 (see FIG. 4) is provided is located close to the second paper processing apparatus 200 (see FIG. 2).

In a case where the orientation of the third paper processing apparatus 300 is changed, for example, a portion functioning as the downstream side transport mechanism 360 before the change of the orientation functions as the pre-rotation transport mechanism 330 and transports the paper P toward the rotating mechanism 320.

In the present exemplary embodiment, the pre-rotation transport mechanism 330, the first post-rotation transport mechanism 340, the second post-rotation transport mechanism 350, and the downstream side transport mechanism 360 have identical configurations so that the third paper processing apparatus 300 may be placed in any orientation. The first movement mechanism 410 and the second movement mechanism 420 also have identical configurations.

Although the configuration in which the four transport paths 70 that radially extend are provided has been described as an example, this is not restrictive. For example, it is also possible to employ a configuration in which three transport paths 70 radially extend or a configuration in which five or sixth transport paths 70 radially extend.

The shape of the third paper processing apparatus 300 viewed from above is not limited to a rectangular shape described above, and may be a shape other than a rectangular shape, such as a triangular shape, a pentagonal shape, or a hexagonal shape.

In the configuration in which three transport paths 70 radially extend or the configuration in which five or sixth transport paths 70 radially extend, the shape of the third paper processing apparatus 300 may be a triangular shape, a pentagonal shape, or a hexagonal shape.

In the configuration in which three transport paths 70 radially extend or the configuration in which five or sixth transport paths 70 radially extend, a rotation angle by which the paper P is rotated by the rotating mechanism 320 is an angle other than 90°.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A recording medium processing apparatus including:
an apparatus body;
plural transport paths that are provided in the apparatus body and radially extend from a predetermined place and along which a transported recording medium passes; and
plural opening and closing members that are openable and closable with respect to the apparatus body and are disposed so that positions thereof in a circumferential direction of the plural transport paths that are arranged radially are different.
   (((2)))

The recording medium processing apparatus according to (((1))), in which the plural opening and closing members are provided corresponding to individual transport paths included in the plural transport paths.

(((3)))

The recording medium processing apparatus according to (((2))), in which each of the plural opening and closing members is provided at a position facing a corresponding one of the plural transport paths.

(((4)))

The recording medium processing apparatus according to (((2))) or (((3))), in which
when a user opens any of the plural opening and closing members, a side member provided beside a corresponding one of the plural transport paths moves along with the opening and closing member away from the corresponding one of the plural transport paths.
   (((5)))

The recording medium processing apparatus according to (((4))), in which
a guide member that guides a recording medium passing along the transport path is provided as the side member beside the transport path; and
when the user opens the opening and closing member, the guide member moves away from the transport path along with the opening and closing member.
   (((6)))

The recording medium processing apparatus according to any one of (((2))) to (((5))), in which
each of the plural opening and closing members is rotatable about a rotary axis extending in a direction crossing a direction in which a corresponding one of the plural transport paths extends.
   (((7)))

The recording medium processing apparatus according to (((6))), in which
each of the plural opening and closing members includes a first end portion located close to the predetermined place and a second end portion located on a side opposite to the first end portion; and
the rotary axis is provided on a side where the second end portion of the opening and closing member is provided.
   (((8)))

The recording medium processing apparatus according to (((1))), in which
an opening created by opening any of the plural opening and closing members allows a user to touch a recording medium located on a transport path included in the plural transport paths.
   (((9)))

The recording medium processing apparatus according to (((8))), in which
a rotating body that rotates a recording medium is provided at the predetermined place;
the opening allows the user to touch a recording medium located at a position facing the rotating body; and
the opening allows the user to touch both the recording medium located on the transport path and the recording medium located at the position facing the rotating body.
   (((10)))

The recording medium processing apparatus according to (((1))), in which
a rotating body that rotates a recording medium is provided at the predetermined place; and
an opening created by opening any of the plural opening and closing members allows a user to touch a recording medium located at a position facing the rotating body.
   (((11)))

The recording medium processing apparatus according to any one of (((1))) to (((10))), in which
a rotating body that rotates a recording medium is provided at the predetermined place; and
the rotating body is supported by a member that is an unmovable member and that is other than the opening and closing members among members that constitute the recording medium processing apparatus.
   (((12)))

A recording medium processing apparatus including:
an apparatus body;
a rotating body that is provided in the apparatus body, rotates about a rotary axis extending along an up-down direction, and rotates a recording medium;
plural transport paths that extend from a place where the rotating body is provided toward side walls of the apparatus body and along which a transported recording medium passes; and
plural opening and closing members that are openable and closable with respect to the apparatus body and are disposed at positions deviated from a line extended from the rotary axis of the rotating member so that positions thereof in a direction in which the rotating body rotates are different.
   (((13)))

A recording medium processing apparatus including:
an apparatus body;
plural transport paths that are provided in the apparatus body and radially extend from a predetermined place and along which a transported recording medium passes;
a movable body that is movable away from the plural transport paths in a direction in which a central axis of the plural transport paths that radially extend extends; and
a side member that is provided beside individual transport paths included in the plural transport paths and moves away from the transport paths along with movement of the movable body.
   (((14)))

An image forming system including:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to any one of (((1))) to (((13))).

What is claimed is:

1. A recording medium processing apparatus comprising:
an apparatus body;
a plurality of transport paths that are provided in the apparatus body and radially extend from a predetermined place and along which a transported recording medium passes; and
a plurality of opening and closing members that are openable and closable with respect to the apparatus body and are disposed so that positions thereof in a circumferential direction of the plurality of transport paths that are arranged radially are different.

2. The recording medium processing apparatus according to claim 1, wherein:
the plurality of opening and closing members are provided corresponding to individual transport paths included in the plurality of transport paths.

3. The recording medium processing apparatus according to claim 2, wherein:
each of the plurality of opening and closing members is provided at a position facing a corresponding one of the plurality of transport paths.

4. The recording medium processing apparatus according to claim 2, wherein:
when a user opens any of the plurality of opening and closing members, a side member provided beside a corresponding one of the plurality of transport paths moves along with the opening and closing member away from the corresponding one of the plurality of transport paths.

5. The recording medium processing apparatus according to claim 4, wherein:
a guide member that guides a recording medium passing along the transport path is provided as the side member beside the transport path; and
when the user opens the opening and closing member, the guide member moves away from the transport path along with the opening and closing member.

6. The recording medium processing apparatus according to claim 2, wherein:
each of the plurality of opening and closing members is rotatable about a rotary axis extending in a direction crossing a direction in which a corresponding one of the plurality of transport paths extends.

7. The recording medium processing apparatus according to claim 6, wherein:
each of the plurality of opening and closing members includes a first end portion located close to the predetermined place and a second end portion located on a side opposite to the first end portion; and
the rotary axis is provided on a side where the second end portion of the opening and closing member is provided.

8. The recording medium processing apparatus according to claim 1, wherein:
an opening created by opening any of the plurality of opening and closing members allows a user to touch a recording medium located on a transport path included in the plurality of transport paths.

9. The recording medium processing apparatus according to claim 8, wherein:
a rotating body that rotates a recording medium is provided at the predetermined place;
the opening allows the user to touch a recording medium located at a position facing the rotating body; and
the opening allows the user to touch both the recording medium located on the transport path and the recording medium located at the position facing the rotating body.

10. The recording medium processing apparatus according to claim 1, wherein:
a rotating body that rotates a recording medium is provided at the predetermined place; and
an opening created by opening any of the plurality of opening and closing members allows a user to touch a recording medium located at a position facing the rotating body.

11. The recording medium processing apparatus according to claim 1, wherein:
a rotating body that rotates a recording medium is provided at the predetermined place; and
the rotating body is supported by a member that is an unmovable member and that is other than the opening and closing members among members that constitute the recording medium processing apparatus.

12. A recording medium processing apparatus comprising:
an apparatus body;
a rotating body that is provided in the apparatus body, rotates about a rotary axis extending along an up-down direction, and rotates a recording medium;
a plurality of transport paths that extend from a place where the rotating body is provided toward side walls of the apparatus body and along which a transported recording medium passes; and
a plurality of opening and closing members that are openable and closable with respect to the apparatus body and are disposed at positions deviated from a line extended from the rotary axis of the rotating member so that positions thereof in a direction in which the rotating body rotates are different.

13. A recording medium processing apparatus comprising:
an apparatus body;
a plurality of transport paths that are provided in the apparatus body and radially extend from a predetermined place and along which a transported recording medium passes;
a movable body that is movable away from the plurality of transport paths in a direction in which a central axis of the plurality of transport paths that radially extend extends; and
a side member that is provided beside individual transport paths included in the plurality of transport paths and moves away from the transport paths along with movement of the movable body.

14. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 1.

15. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 2.

16. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 3.

17. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 4.

18. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 5.

19. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 6.

20. An image forming system comprising:
an image forming apparatus that forms an image on a recording medium; and
a recording medium processing apparatus that processes a recording medium on which an image has been formed by the image forming apparatus,
wherein the recording medium processing apparatus includes the recording medium processing apparatus according to claim 7.
